(19) United States
(12) Patent Application Publication
(10) Pub. No.: US 2012/0300131 A1
(43) Pub. Date: Nov. 29, 2012

(54) DISPLAY DEVICE AND TELEVISION RECEIVER

(75) Inventor: Yoshiki Takata, Osaka-shi (JP)

(73) Assignee: SHARP KABUSHIKI KAISHA, Osaka-shi, Osaka (JP)

(21) Appl. No.: 13/576,487

(22) PCT Filed: Jan. 24, 2011
(86) PCT No.: PCT/JP2011/051173

§ 371 Date: Aug. 1, 2012

(30) Foreign Application Priority Data
Feb. 17, 2010 (JP) 2010-032842

(51) Int. Cl. H04N 5/44; G09G 5/10

(52) U.S. Cl. 348/725; 345/690; 348/E07.001

(57) ABSTRACT

In a display device, sufficient color reproducibility is maintained while the brightness is maintained at a high level. The liquid crystal display device 10 according to the present invention includes a liquid crystal panel 11 and a backlight unit 12. The panel 11 includes substrates 11a, 11b, a liquid crystal layer 11c arranged between the substrates, and color filters 19 formed on the CF substrate 11a. The color filters include R, G, B, and Y color portions in red, green, blue and yellow, respectively. The backlight unit 12 includes cold cathode tubes 25 to illuminate the display panel 11. The color filters 19 are configured such that a chromaticity of blue in transmitted light passed through the color portions is outside a common gamut 35 on at least one of CIE 1931 and CIE 1976 color space chromaticity diagrams. The common gamut 35 is a region shared by NTSC color gamut 33 corresponding to NTSC standard and EBU color gamut 34 corresponding to EBU standard.

### TECHNICAL FIELD

The present invention relates to a display device and a television receiver.

### BACKGROUND ART

A liquid crystal panel that is a main component of a liquid crystal display device includes a pair of glass substrates and liquid crystals sealed between the glass substrates. One of the glass substrates is an array substrate on which TFTs are arranged. The TFTs are active elements. The other glass substrate is a CF substrate on which color filters are arranged. On an inner surface of the CF substrate opposite the array substrate, color filter including a plurality of color portions in red, green, and blue arranged according to pixels of the array board. Light blocking layers are arranged between the color portions so that colors are not mixed. Light emitted from a backlight unit passes through the liquid crystals. The red, the green and the blue color portions of the color filter selectively pass the light in specific wavelengths corresponding to the colors. As a result, images are displayed on the liquid crystal panel.

To improve the display quality of the liquid crystal display device, an improvement in color reproducibility may be effective. For the improvement, color portions of the color filters may be provided in another color such as cyan (or greenish blue) in addition to the three primary colors of light, which are red, green, and blue. An example is disclosed in Patent Document 1.
Patent Document 1: Japanese Unexamined Patent Publication No. 2006-58332

### Problem to be Solved by the Invention

When the portions of the color filter are provided in another color in addition to the three primary colors of light, display images is more likely to be affected by the added color. To reduce such an effect, amounts of transmitted light passing through the color portions may be controlled through TFTs driven for respective pixels of a liquid crystal panel. With this configuration, chromaticity of the display images (transmitted light) can be corrected. However, the amounts of light passing through the color portions tend to decrease according to the correction of the chromaticity. Therefore, brightness may decrease.

In view of such a problem, the inventor of this application has reached an idea. Namely, the inventor has assumed that chromaticity of display images can be corrected without a reduction in brightness by adjusting chromaticity of light sources in a backlight unit for illuminating a liquid crystal panel. Furthermore, a color added to multiple primary color-type liquid crystal panel other than three primary colors may be different from cyan. Further, although a cold cathode tube may be used to reduce the production cost, what kind of problem may occur in the correction of the chromaticity thereof has not been sufficiently examined.

### DISCLOSURE OF THE PRESENT INVENTION

The present invention was made in view of the foregoing circumstances. An object of the present invention is to sufficiently maintain color reproducibility while brightness of transmitted light is maintained at a high level.

### Means for Solving the Problem

To solve the above problem, a display device according to the present invention includes a display panel and a lighting unit. The display panel includes a pair of substrates, a substance having optical characteristics varying according to an application of electric field and arranged between the substrates, and color filter formed on one of the substrates. The color filter includes a plurality of color portions in red, green, blue and yellow, respectively. The lighting unit is configured to illuminate the display panel. The lighting unit includes cold cathode tubes as light sources. The color filters are configured such that a chromaticity of blue in transmitted light that is emitted from the cold cathode tubes and passed through the color portions is outside a common gamut on at least one of CIE 1931 color space chromaticity diagram and CIE 1976 color space chromaticity diagram. The common gamut is a region shared by NTSC color gamut corresponding to NTSC standard and EBU color gamut corresponding to EBU standard.

The color filter including the color portion in yellow in addition to the color portions in red, green and blue that are three primary colors of light are provided on one of the substrates of the display panel. With this configuration, a color reproduction range, colors in which are perceivable to human eyes, can be expanded, that is, the color gamut can be expanded. Furthermore, reproducibility of colors of objects in nature can be enhanced and thus display quality can be improved. Light transmitted through the color portion in yellow among the color portions of the color filters has a wavelength close to the visible peak. Namely, people perceive the light as bright light even though the light is emitted with low energy. Even when the outputs of the light sources are reduced, sufficient brightness still can be achieved. Therefore, the power consumption of the light sources can be reduced and the lighting unit is provided with high environmental efficiency. Because the high brightness can be achieved as described above, clear contrast can be achieved. Therefore, the display quality can be further improved.

When the color portion in yellow is included in the color filter, the overall color of light exiting from the display panel (transmitted light), that is, the overall color of the display images tend to be yellowish. To solve this problem, the amounts of light passing through the color portions (transmitted light) may be controlled by controlling an application of electric field for each of the color portions and the chromaticity of the display images may be corrected. An overall amount of transmitted light tends to decrease according to the correction of the chromaticity and thus the brightness of the transmitted light may decrease. In view of such a problem, the inventor of this application has created a method for correcting the chromaticity of display images without a reduction in brightness of the light exiting from the display panel by adjusting the chromaticity of light sources in the lighting unit.

Instead of LED, cold cathode tubes may be preferably used as light sources of a lighting device in some cases to reduce the production cost. However, a further study conducted by the inventor of the present invention revealed that the cold cathode tube may have lower brightness and lower transmitted light brightness than the LED. This may occur when the chromaticity of the cold cathode tube as a light source is adjusted to be shifted to the blue side, which is a complementary color of yellow, in order to correct the chromaticity of display images. This problem may be caused by chromaticity and brightness characteristics of the cold cathode tube and compatibility of optical characteristics with the liquid crystal display panel including a color portion in yellow.

To solve the above problem, according to the present invention, the color filters are configured such that a chromaticity of blue in transmitted light passed through the color portions is outside a common gamut on at least one of CIE 1931 color space chromaticity diagram and CIE 1976 color space chromaticity diagram. The common gamut is a region shared by NTSC color gamut corresponding to NTSC standard and EBU color gamut corresponding to EBU standard. With this configuration, the color gamut of blue in the transmitted light can include the substantially entire of the common gamut, and thus sufficient color reproducibility can be achieved. In addition, in the setting of the color filter, although the color reproducibility is lowered, the amount of blue light in the transmitted light can be increased as the chromaticity of blue in the transmitted light is closer to the common gamut in the outside of the common gamut. Accordingly, in the adjustment of chromaticity of the cold cathode tube, the chromaticity does not need to be adjusted to be bluish. In addition, the overall amount of the transmitted light increases, and thus the brightness of the transmitted light can be improved. As a result, the reduction in brightness of the cold cathode tube due to the chromaticity adjustment is less likely to occur, and high brightness of the transmitted light can be maintained.

The above-described “NTSC color gamut corresponding to NTSC standard” is a region inside a triangle defined by three (x, y) coordinates: (0.14, 0.08), (0.21, 0.71), and (0.67, 0.33) on the CIE 1931 color space chromaticity diagram and a region inside a triangle defined by three (u′, v′) coordinates: (0.0757, 0.5757), (0.1522, 0.1957), and (0.4769, 0.5285) on the CIE 1976 color space chromaticity diagram.

The above-described “EBU color gamut corresponding to EBU standard” is a region inside a triangle defined by three (x, y) coordinates: (0.15, 0.06), (0.3, 0.6), and (0.64, 0.33) on the CIE 1931 color space chromaticity diagram and a region inside a rectangle defined by three (u′, v′) coordinates: (0.1250, 0.5625), (0.1754, 0.1579), and (0.4507, 0.5229) on the CIE 1976 color space chromaticity diagram.

The above-described “common gamut” is a region inside a rectangle defined by four (x, y) coordinates: (0.1579, 0.0884), (0.3, 0.6), and (0.4616, 0.2317) on the CIE 1931 color space chromaticity diagram and a region inside a rectangle defined by four (u′, v′) coordinates: (0.125, 0.5625), (0.1686, 0.2125), (0.3801, 0.4293), and (0.4507, 0.5229) on the CIE 1976 color space chromaticity diagram.

The following configuration may be preferable as embodiments of the present invention.

(1) The color filters are configured such that the chromaticity of blue in the transmitted light is inside the EBU color gamut on at least one of CIE 1931 color space chromaticity diagram and CIE 1976 color space chromaticity diagram. In the setting of the color filter, the amount of blue light in the transmitted light can increase as the chromaticity of blue in the transmitted light is closer to the common gamut in the outside of the common gamut and the chromaticity of blue in the transmitted light tends to shift to the yellow side. In the color gamut of blue in the outside of the common gamut, a region inside the EBU color gamut is relatively shifted to the yellow side and a region outside the EBU color gamut is relatively shifted to the blue side. Accordingly, the amount of blue light in the transmitted light is large when the chromaticity of blue in the transmitted light is set to be outside the common gamut and the inside the EBU color gamut, compared with the chromaticity of blue that is set to be outside the common gamut and outside the EBU color gamut. With this configuration, the brightness of the cold cathode tube is less likely to be reduced in the chromaticity adjustment of the cold cathode tube, and thus the brightness of the transmitted light can be further increased.

The above-described a region “outside the common gamut and inside the EBU color gamut” is a region inside a triangle defined by three (x, y) coordinates: (0.15, 0.06), (0.1579, 0.0884), and (0.4616, 0.2317) on the CIE 1931 color space chromaticity diagram and a region inside a rectangle defined by three (u′, v′) coordinates: (0.1686, 0.2125), (0.81754, 0.1579), and (0.3801, 0.4293) on the CIE 1976 color space chromaticity diagram.

(2) The color filters are configured such that the chromaticity of blue in the transmitted light is outside the EBU color gamut on at least one of the CIE 1931 color space chromaticity diagram and the CIE 1976 color space chromaticity diagram. In the setting of the color filter, the color gamut of blue in the transmitted light is expanded and the chromaticity of blue in the transmitted light tends to shift to the blue side as the chromaticity of blue is set further from the common gamut. In the color gamut of blue in the outside of the common gamut, a region inside the EBU color gamut is relatively shifted to the yellow side and a region outside the EBU color gamut is relatively shifted to the blue side. Accordingly, when the chromaticity of blue in the transmitted light is set to be outside the common gamut and the EBU color gamut, the color gamut of blue in the transmitted light become large compared with the chromaticity of blue that is set to be outside the common gamut and inside the EBU color gamut. Accordingly, high color reproducibility can be achieved.

(3) The color filters are configured such that the chromaticity of blue in the transmitted light has a y value of 0.055 or larger on the CIE 1931 color space chromaticity diagram. With this configuration, the amount of blue light in the transmitted light tends to increase as the y value becomes larger than 0.055 (closer to the common gamut) on the CIE 1976 color space chromaticity diagram, and thus the reduction in brightness of the cold cathode tube that may occur in the chromaticity adjustment of the cold cathode tube is less likely to occur, and further the brightness of the transmitted light can be improved. The coordinates having the y value of 0.055 on the CIE 1931 color space chromaticity diagram is outside the NTSC color and the EBU color gamut.

(4) The color filters are configured such that the chromaticity of blue in the transmitted light has a v′ value of 0.147 or larger on the CIE 1976 color space chromaticity diagram. With this configuration, the amount of blue light in the transmitted light tends to increase as the v′ value becomes larger than 0.147 (is closer to the common gamut) on the CIE 1976 color space chromaticity diagram. Accordingly, the reduction in brightness of the cold cathode tube that may occur in the chromaticity adjustment of the cold cathode tube is less likely to occur. The coordinate having the v′ value of 0.147 on the CIE 1976 color space chromaticity diagram is outside the NTSC color gamut and inside the EBU color gamut.

(5) The color portions in red, green, blue, and yellow have equal areas. If the area ratio of the color portions is varied to control the chromaticity of blue in the transmitted light, a special apparatus for producing a display panel is required. According to the present invention, four color portions have an equal area ratio, like a display panel including a conventional color filters having three color portions in red, green, and blue, and thus the same apparatus for producing the display panel having three color portions can be used. As a result, the cost for producing the display panel including the color filters having four color portions can be sufficiently lowered.

(6) The color portion in blue has a smaller thickness than each of the color portion in red and the color portion in green. With this configuration, the amount of blue light increases compared with the case that the color portions in blue, red, and green have an equal thickness, although the color gamut of blue in the transmitted light decreases. As a result, the reduction in brightness of the cold cathode tube that may occur in the chromaticity adjustment of the cold cathode tube is less likely to occur, and thus the brightness of the transmitted light can be improved.

(7) The color portion in red has a thickness substantially equal to that of the color portion in green. With this configuration, capacitance between the substrates at the color portions in red and green can be equal. Thus, optical characteristics of the substance between the substrates can be readily controlled by an application of electric field. As a result, light transmissibility with respect to the color portions in red and green can be readily controlled, and thus a circuit design relating to the display panel can be simplified.

(8) The color portion in yellow has a thickness equal to that of each of the color portion in red and the color portion in green. With this configuration, capacitance between the substrates at the color portion in yellow, in addition to the color portions in red and green, can be substantially equal. Thus, a circuit design relating to the display panel can be more simplified.

(9) The color portion in blue has a thickness that is 50 to 90% of the thickness of each of the color portion in red and the color portion in green. If the color portion in blue has a thickness that is smaller than 50% of the thickness of each of the color portions in red and green, the capacitance to be formed between the substrates is likely to be largely different between the color portions in red and green and the color portion in blue. As a result, the optical characteristics of the substance provided between the substrates may not be properly controlled by the application of electric field. On the other hand, if the color portion in blue is larger than 90% of the thickness of each of the color portion in red and the color portion in green, the difference between the thickness of the color portions in red and green and the thickness of the color portion in blue is too small. As a result, the amount of blue light in the transmitted light increases only a little, and thus a sufficient effect may not be obtained. By setting the thickness within a range of 50 to 90% as above, the optical characteristics of the substance provided between the substrates can be properly controlled by the application of electric field, and the amount of blue light in the transmitted light can be sufficiently increased to sufficiently improve the brightness of the transmitted light.

(10) The color portion in blue has a thickness that is 57.1 to 85.8% of the thickness of each of the color portion in red and the color portion in green. With this configuration, the optical characteristics of the substance provided between the substrates can be properly controlled by the application of electric field, and the amount of blue light in the transmitted light can be sufficiently increased to sufficiently improve the brightness of the transmitted light.

(11) The color portion in red and the color portion in green each have a thickness of 2.1 μm and the color portion in blue has a thickness of 1.2 to 1.8 μm. By setting the thickness of the color portions as above, the optical characteristics of the substance provided between the substrates can be properly controlled by the application of electric field, and the amount of blue light in the transmitted light can be sufficiently increased to sufficiently improve the brightness of the transmitted light.

(12) The color portions contain pigments. The color portion in blue has a lower pigment concentration than each of the color portion in red and the color portion in green. With this configuration, the amount of blue light in the transmitted light increases compared with the case that the color portions have the same pigment concentration, although the color gamut of blue in the transmitted light decreases. Accordingly, the reduction in brightness of the cold cathode tube that may occur in the chromaticity adjustment of the cold cathode tube is less likely to occur, and thus the brightness of the transmitted light can be further improved.

(13) The color portions in red, green, blue, and yellow have a substantially equal thicknesses. With this configuration, capacitance between the substrates at the color portions included in the color filter can be substantially equal. Thus, optical characteristics of the substance between the substrates can be readily controlled by the application of electric field. As a result, light transmissibility with respect to the color portions can be readily controlled, and thus a circuit design relating to the display panel can be simplified.

(14) The color filters are configured such that a chromaticity of red in the transmitted light is inside the common gamut on at least one of the CIE 1931 color space chromaticity diagram and the CIE 1976 color space chromaticity diagram. With this configuration, since the chromaticity of red in the transmitted light is inside the common gamut, the amount of red light in the transmitted light becomes large compared with the case that the chromaticity of red in the transmitted light is outside the common gamut. Accordingly, the brightness of the transmitted light can be improved.

(15) The color portion in red has a smaller thickness than each of the color portion in blue and the color portion in green. With this configuration, the amount of red light in the transmitted light increases compared with the case that the color portions have the same thickness, although the color gamut of red in the transmitted light decreases. As a result, the brightness of the transmitted light can be improved.

(16) The color filters are configured such that a chromaticity of red in the transmitted light is outside the common gamut on at least one of the CIE 1931 color space chromaticity diagram and the CIE 1976 color space chromaticity diagram. With this configuration, since the chromaticity of red in the transmitted light is outside the common gamut, the color gamut of red in the transmitted light is expanded compared the case where the chromaticity of red in the transmitted light is inside the common gamut. As a result, color reproducibility can be improved.

(17) The color portion in red has a larger thickness than each of the color portion in blue and the color portion in green. With this configuration, the color gamut of red in the transmitted light is expanded compared with the case that the color portions have the same thickness, although the amount of red light in the transmitted light decreases. Accordingly, high color reproducibility can be obtained.

(18) The color filters are configured such that a chromaticity of green in the transmitted light is outside the common gamut on at least one of the CIE 1931 color space chromaticity diagram and the CIE 1976 color space chromaticity diagram. With this configuration, since the chromaticity of green in the transmitted light is outside the common gamut, the color gamut of green in the transmitted light is expanded compared with the case that the chromaticity of green in the transmitted light is inside the common gamut. Accordingly, color reproducibility can be improved.

(19) The color filters are configured such that a chromaticity of yellow in the transmitted light is outside the common gamut on at least one of the CIE 1931 color space chromaticity diagram and the CIE 1976 color space chromaticity diagram. With this configuration, since the chromaticity of yellow in the transmitted light is outside the common gamut, the color gamut of yellow in the transmitted light is expanded compared with the case that the chromaticity of yellow in the transmitted light is inside the common gamut. Accordingly, color reproducibility can be improved.

(20) The color gamut of the transmitted light covers 70% of the NTSC color gamut. With this configuration, sufficient color reproducibility for displaying image can be achieved, and thus high display quality can be achieved.

(21) The cold cathode tubes are arranged so as to be parallel with each other. With this configuration, the uneven brightness of the transmitted light is less likely to occur.

(22) The display panel may be a liquid crystal panel including liquid crystals as substances that vary optical characteristics according to an application of electric field. This configuration can be used in various applications including television sets and personal computer displays. This configuration is especially preferable for large-screen applications.

Next, to solve the problems described earlier, a television receiver according to the present invention includes the above display device and a receiver configured to receive television signals.

The display device of the television receiver configured to display television images according to the television signals can properly correct the chromaticity of the display images while the brightness is maintained at a high level. Therefore, the television images can be provided with high display quality.

The television receiver may include an image converter circuit configured to convert the television signals output from the receiver into red, green, blue, and yellow image signals. The television signals may be converted into the color signals corresponding to the color portions in red, green, blue, and yellow, respectively, by the image converter circuit. Therefore, the television images can be displayed with high display quality.

### Advantageous Effect of the Invention

According to the present invention, the color reproducibility can be sufficiently maintained while the brightness is maintained at a high level.

### BRIEF DESCRIPTION OF THE DRAWINGS

FIG. 1 is an exploded perspective view illustrating a general construction of a television receiver according to a first embodiment of the present invention;

FIG. 2 is an exploded perspective view illustrating a general construction of a liquid crystal display device included in the television receiver;

FIG. 3 is a cross-sectional view illustrating a cross-sectional configuration (a cross-sectional view of color portions according to Example 1) of the liquid crystal display device along the long-side direction;

FIG. 4 is a magnified view of an array board illustrating a plan-view configuration;

FIG. 5 is a magnified view of a CF board illustrating a plan-view configuration;

FIG. 6 is a cross-sectional view of the liquid crystal display device along the short-side direction illustrating a cross-sectional configuration;

FIG. 7 is a cross-sectional view of the liquid crystal display device along the long-side direction illustrating a cross-sectional configuration;

FIG. 8 is a CIE 1931 color space chromaticity diagram illustrating a relationship between the chromaticity and the brightness of an LED;

FIG. 9 a CIE 1931 color space chromaticity diagram illustrating a relationship between the chromaticity and the brightness of a cold cathode tube;

FIG. 10 is a CIE 1931 color space chromaticity diagram on which coordinates in Table 2 and Table 3 are indicated;

FIG. 11 is a CIE 1976 color space chromaticity diagram on which coordinates in Table 2 and Table 3 are indicated;

FIG. 12 is a cross-sectional view illustrating a cross-sectional configuration of color portions according to Examples 2 to 4 of the present invention;

FIG. 13 is a cross-sectional view illustrating a cross-sectional configuration of color portions according to Examples 5 and 6 of the present invention;

FIG. 14 is a cross-sectional view illustrating a cross-sectional configuration of color portions according to Examples 7 to 9 of the present invention;

FIG. 15 is a cross-sectional view illustrating a cross-sectional configuration of color portions according to a second embodiment of the present invention;

FIG. 16 is a cross-sectional view illustrating a cross-sectional configuration of color portions according to another embodiment (1) of the present invention;

FIG. 17 is a cross-sectional view illustrating a cross-sectional configuration of color portions according to another embodiment (2) of the present invention;

FIG. 18 is a magnified plan view illustrating a plan-view configuration of a CF substrate according to another embodiment (3) of the present invention; and

FIG. 19 is a magnified plan view illustrating a plan-view configuration of a CF substrate according to another embodiment (4) of the present invention.

### MODE FOR CARRYING OUT THE INVENTION

### First Embodiment

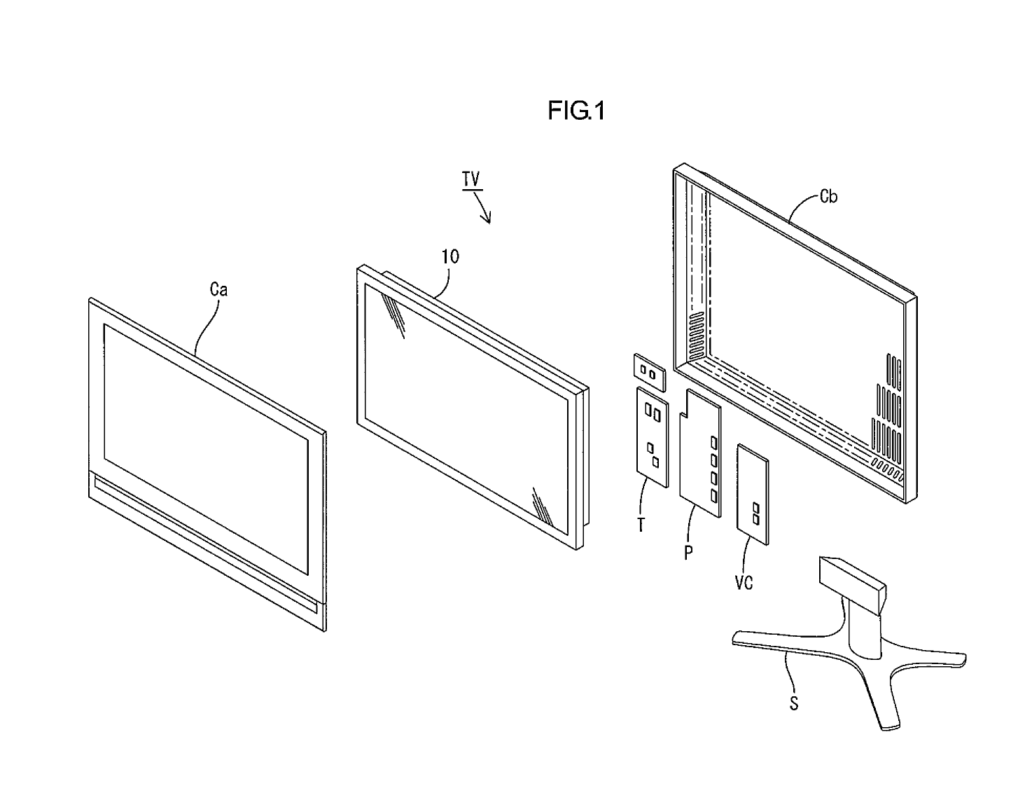

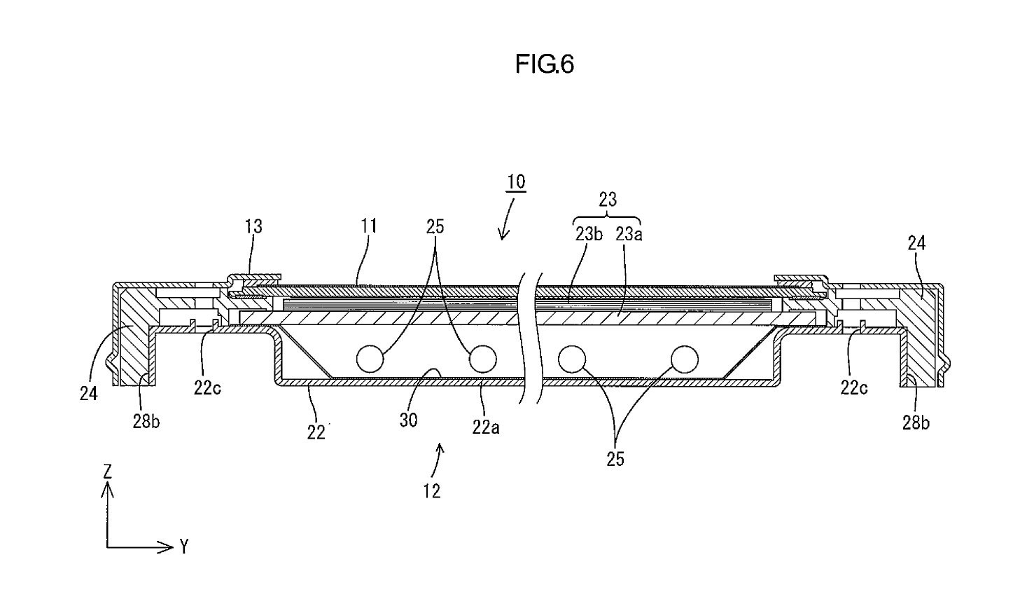

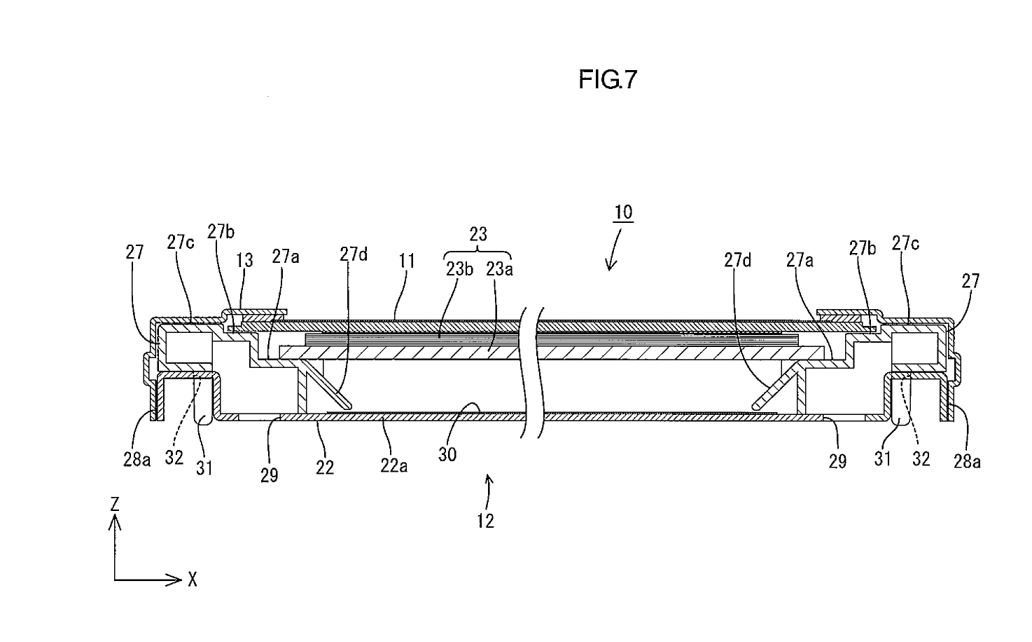

A first embodiment of the present invention will be explained with reference to FIGS. 1 to 14. In this embodiment, a liquid crystal display device 10 will be illustrated. X-axis, Y-axis and Z-axis are indicated in some drawings. The axes in each drawing correspond to the respective axes in other drawings. The upper side and the lower side in FIGS. 6 and 7 correspond to the front side and the rear side, respectively.

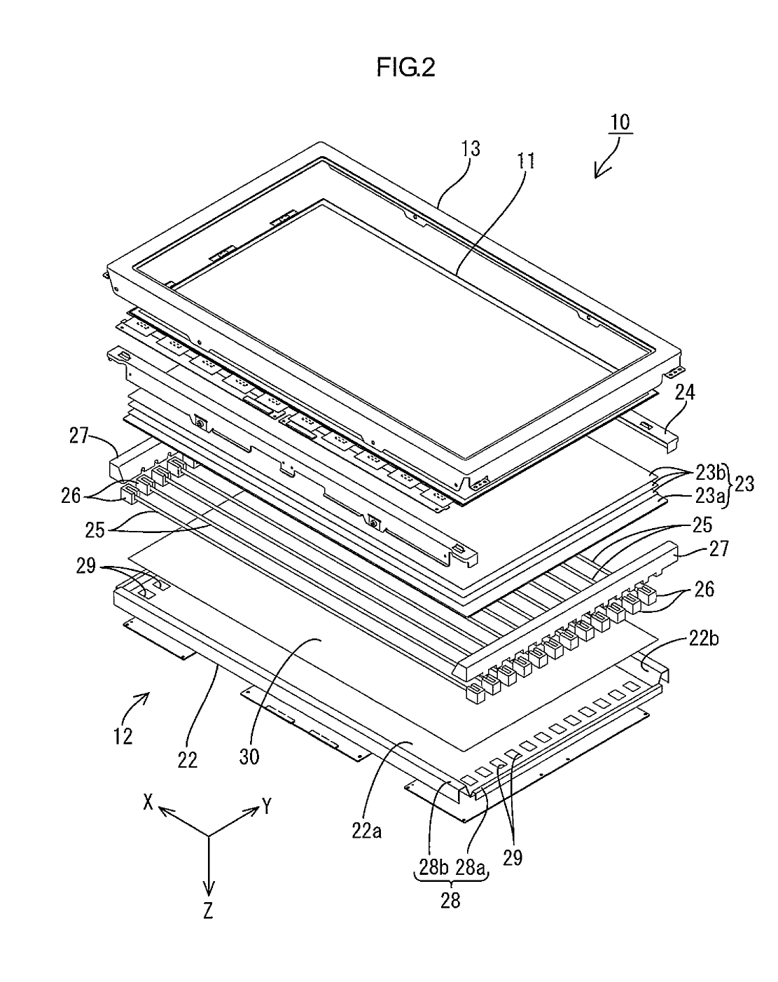

As illustrated in FIG. 1, a television receiver TV of this embodiment includes the liquid crystal display device 10, front and rear cabinets Ca, Cb that house the liquid crystal display device 10 therebetween, a power source P, a tuner (a receiver) T, an image converter circuit board VC, and a stand S. An overall shape of the liquid crystal display device (a display device) 10 is a landscape rectangular. The liquid crystal display device 10 is held with the long-side direction thereof substantially aligned with the horizontal direction (the X-axis direction) and the short-side direction thereof substantially aligned with the vertical direction (the Y-axis direction). As illustrated in FIG. 2, the liquid crystal display device 10 includes a liquid crystal panel 11 as a display panel, and a backlight unit (a lighting unit) 12 as an external light source. They are integrally held by a bezel 13 having a frame-like shape. The image converter circuit board VC is configured to convert television image signals from the tuner T into image signals for the liquid crystal display device 10.

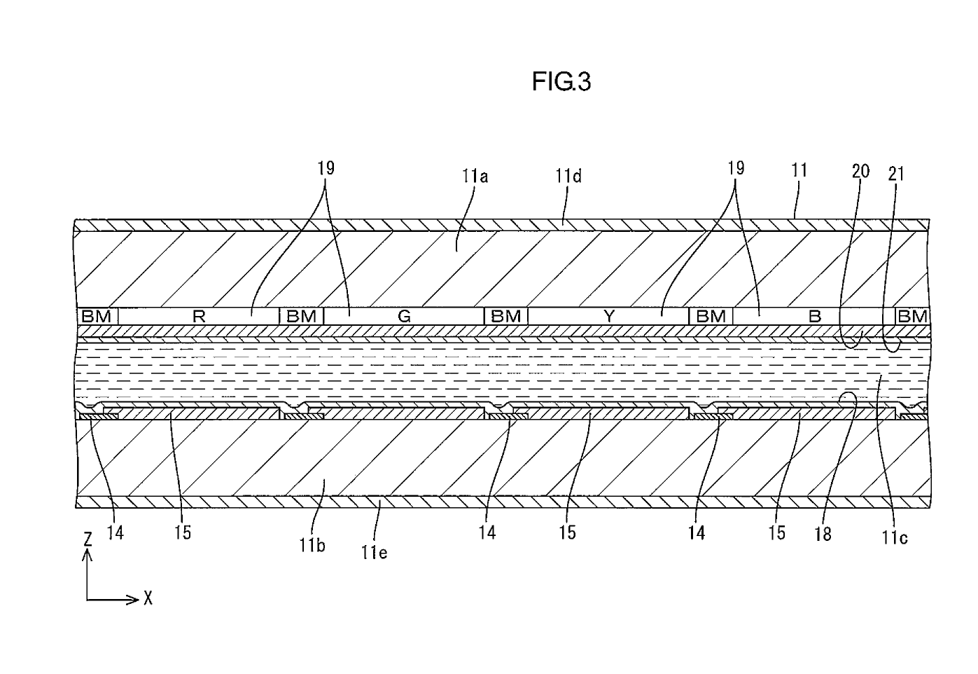

A configuration of the liquid crystal panel 11 included in the liquid crystal display device 10 will be explained in detail. The liquid crystal panel 11 has a landscape rectangular overall shape. As illustrated in FIG. 3, the liquid crystal panel 11 includes a pair of transparent glass substrates 11a, 11b (capable of light transmission) and a liquid crystal layer 11c. The liquid crystal layer 11c is provided between the substrates 11a and 11b. The liquid crystal layer 11c includes liquid crystals having optical characteristics that vary according to electric fields applied thereto. The substrates 11a and 11b are bonded together with a predetermined gap therebetween with sealant that is not illustrated. The long-side direction and the short-side direction of the liquid crystal panel 11 are aligned with the X-axis direction and the Y-axis direction, respectively.

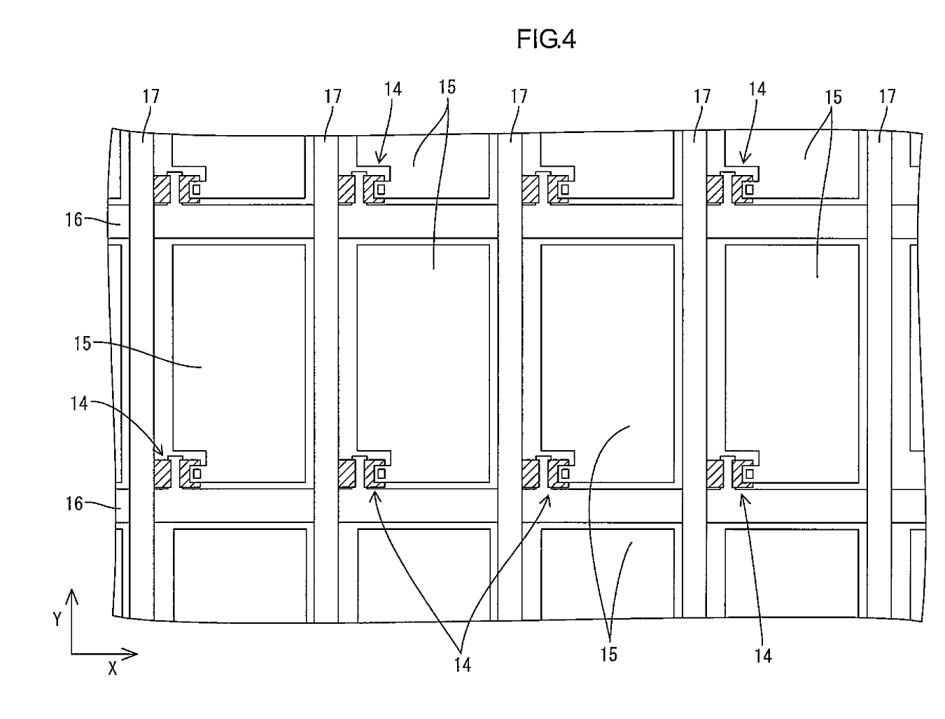

One of the substrates 11a, 11b on the front side is the CF substrate 11a and the other one of the substrates 11a, 11b on the rear side is the array board 11b. On the inner surface of the array board 11b, that is, a surface on the liquid crystal layer 11c side (opposite to the CF board 11a), a number of thin film transistors (TFTs) 14 and pixel electrodes 15 are arranged in a matrix as illustrated in FIG. 4. The TFTs 14 are switching elements. Furthermore, gate lines 16 and source lines 17 arranged perpendicular to each other and around the TFTs 14 and the pixel electrodes 15. Each pixel electrode 15 has a rectangular shape with the long-side direction and the short-side direction aligned with the Y-axis direction and the X-axis direction, respectively. The pixel electrode 15 is a transparent electrode made of indium tin oxide (ITO) or zinc oxide (ZnO). The gate lines 16 and the source lines 17 are connected to gate lines and source lines of the respective TFTs 14. The pixel electrodes 15 are connected to drain electrodes of the respective TFTs 14. An alignment film 18 is arranged on the liquid crystal layer 11c sides of the TFTs 14 and the pixel electrodes 15. The alignment film 18 is provided for alignment of liquid crystal molecules. In end portions of the array board 11b, terminals extended from the gate lines 16 and the source lines 17 are provided. A driver IC for driving the liquid crystal panel 11 is pressure bonded to the terminals via an anisotropic conductive film (ACF). The driver IC is not illustrated in the drawings. The driver IC is electrically connected to a display control circuit board via various wiring boards. The display control circuit board is not illustrated in the drawings. The display control circuit board is connected to the image converter board VC of the television receiver TV and configured to feed driving signals to the lines 16 and 17 according to output signals from the image converter circuit board VC via the driver IC.

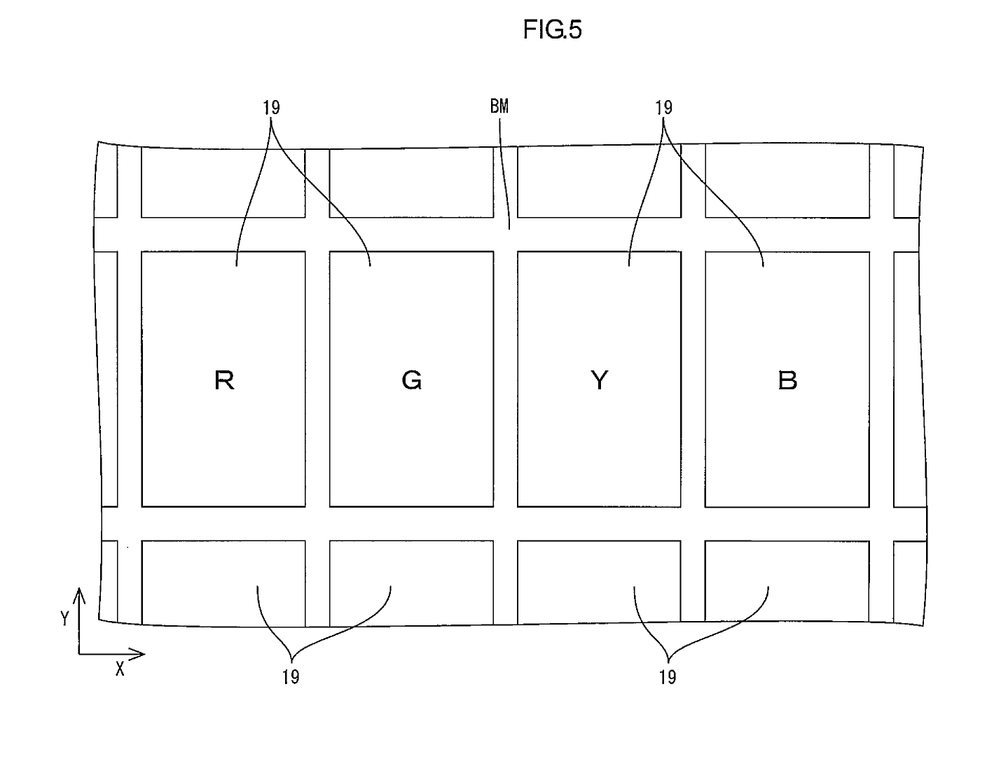

On the inner surface of the CF board 11a on the liquid crystal layer 11c side (opposite to the array board 11b), color filters 19 including a number of R, G, B, and Y color portions arranged in a matrix according to the pixels on the array board 11b side, as illustrated in FIGS. 3 and 5. The color filters 19 includes the Y color portion in yellow in addition to the R color portion in red, the G color portion in green, and the B color portion in blue. Red, green and blue are three primary colors of light. The R color potion, the G color portion, the B color portion, and the Y color portion selectively pass the respective colors (or wavelengths) of light. The color filters 19 include the R color portion in red, the G color portion in green, the Y color portion in yellow, and the B color portion in blue arranged in this sequence from the left side in FIG. 5 along the X-axis direction. Each of the R color portion, the G color portion, the B color portion, and the Y color portion has a rectangular shape with the long-side direction and the short-side direction thereof aligned with the X-axis direction and the Y-axis direction, respectively. Areas of the R color portion, the G color portion, the B color portion, and the Y color portion are all the same. In other words, the R, G, B, and Y color portions have the equal area ratio, and pixel (pixel electrodes 15) that are provided on the array substrate 11b and face the R, G, B, and Y color portions have the equal opening ratio. The R, G, B, and Y color portions are made of resin containing red, green, blue, and yellow pigment, respectively. A grid-like light blocking layer (a black matrix) BM is provided between the R color portion, the G color portion, the B color portion, and the Y color portion so that colors are less likely to be mixed. A counter electrode 20 and an alignment film 20 are overlaid with each other on the liquid crystal layer 11c side of the color filters 19 of the CF substrate 11a.

As described above, the liquid crystal display device 10 of this embodiment includes the liquid crystal panel 11 having the color filters 19. The color filters 19 include the color portions in four colors: the R color portion, the G color portion, the B color portion, and the Y color portion. The television receiver TV includes the designated image converter circuit board VC. The image converter circuit board VC converts television image signals from the tuner T to image signals relative to the respective colors of red, green, blue and yellow. The generated color image signals are inputted to the display control circuit board. The display control circuit board drives the TFTs 14 corresponding to the respective colors of the pixels of the liquid crystal panel 11 based on the image signals and controls the amounts of light passing through the R color portion, the G color portion, the B color portion, and the Y color portion, respectively.

Configuration of the backlight unit 12 will be explained. The backlight unit 12 according to the present embodiment includes a cold cathode tube 25 as a light source, because the cold cathode tube can be produced at a lower cost than an LED. As illustrated in FIG. 2, the backlight unit 12 includes a chassis 22, an optical member set 23, and a frame 24. The chassis 22 has a box-like shape with an opening on the light exit side (on the liquid crystal panel 11 side). The optical member set 23 is arranged so as to cover the opening of the chassis 22. The optical member set 23 includes a diffuser plate (a light diffusing member) 23a and a plurality of optical sheets 23b arranged between the diffuser plate 23a and the liquid crystal panel 11. The frame 24 is arranged along the long sides of the chassis 22 such that a long-side edge portion of the diffuser plate 23a is sandwiched between the frame 24 and the chassis 22. In the chassis 22, cold cathode tubes 25 as the light sources, connectors 26, and a holder 27 are housed. The cold cathode tubes 25 are arranged right behind the optical member 23 (the liquid crystal panel 11) so as to face the optical member 23. The connectors 26 are arranged to electrically connect end portions of the cold cathode tubes 25. The holder 27 collectively covers the end portions of the cold cathode tubes 25 and the connectors 26. The backlight unit 12 is a direct type backlight unit. The backlight unit 12 is mounted to the liquid crystal panel 11 by the bezel 13 that has a frame shape, thereby obtaining the liquid crystal display device 10. The light exit side of the backlight unit 12 is the diffuser plate 23a side, not the cold cathode tubes 25 side.

The chassis 22 is made of metal. The chassis 22 includes a bottom plate 22a and an outer peripheral portion 28(including a short-side folded outer peripheral portion 28a and a long-side folded outer peripheral portion 28b). The bottom plate 22a has a rectangular shape. The outer peripheral portion 28 rises from the corresponding side of the bottom plate 22a and is turned back so as to be formed in a substantially U shape. The chassis 22 has a shallow-box-like overall shape. The bottom plate 22a of the chassis 22 includes mounting holes 29 for the connectors 26 on each end portion in the long-side direction. Further, as illustrated in FIG. 6, a fixing hole is formed through an upper surface of the outer peripheral portion 28b of the chassis 22. This enables the bezel 13, frame 24, and the chassis 22 to be united with screws, for example.

A reflection sheet 30 is provided on an inner surface of the bottom plate 22a of the chassis 22 (a surface facing the cold cathode tube 25 and the diffuser plate 23a, a front side surface). The reflection sheet 30 is made of synthetic resin and is arranged so as to cover the almost entire bottom plate surface of the chassis 22. A surface of the reflection sheet 30 has a white color that provides high light reflectivity. The reflection sheet 30 serves as a reflective surface of the chassis 22 that reflects the light emitted from the cold cathode tubes 25 toward the diffuser plate 23a. As illustrated in FIG. 6, each long-side edge portion of the reflection sheet 30 rises so as to cover the outer peripheral portion 28b of the chassis 22. The long-side edge portion is sandwiched between the chassis 22 and the diffuser plate 23a. The reflection sheet 30 reflects the light emitted from the cold cathode tubes 25 toward the diffuser plate 23a.

As illustrated in FIG. 2, the optical member 23 has a landscape rectangular plan-view shape like the liquid crystal panel 11 and the chassis 22. The optical member 23 covers the opening 22b of the chassis 22 and is arranged between the liquid crystal panel 11 and the light guide member 26. The optical member 23 includes the diffuser plate 23a and the optical sheets 23b. The diffuser plate 23a is arranged on the rear side (the cold cathode tubes 25 side, an opposite side from the light exit side). The optical sheets 23b are arranged on the front side (the liquid crystal panel 11 side, the light exit side). The diffuser plate 23a is constructed of a plate-like member in a specified thickness and made of substantially transparent synthetic resin with light-scattering particles dispersed therein. Each optical sheet 23b has a sheet-like shape with a thickness smaller than that of the diffuser plate 23a. Three sheets are overlaid with each other. Examples of the optical sheets 23b are a diffuser sheet, a lens sheet, and a reflection-type polarizing sheet. Each optical sheet 23b can be selected from those sheets accordingly.

As illustrated in FIG. 2, the cold cathode tube 25 has an elongated tubular shape. A long-side direction (axis direction) of the cold cathode tube 25 matches the long-side direction of the chassis 22 (X-axis direction). The clod cathode tubes 25 are housed in the chassis 22 with a predetermined distance therebetween in the short-side direction of the chassis 22 (Y-axis direction) with the axes thereof arranged parallel with each other. The cold cathode tubes 25 are slightly spaced from the bottom plate 22a (reflection sheet 30) and ends thereof are inserted into the connectors 26. The connectors 26 are covered with the holder 27. The connectors 26 are connected to an inverter board (not illustrated) that supplies power for driving the cold cathode tubes 25. The cold cathode tube 25 is a kind of discharging tubes that is an elongated glass tube having a circular cross-sectional shape and includes two electrodes therein on opposite ends thereof. The glass tube is a linear tube. The glass tube constituting the cold cathode tube 25 includes a light emitting substance such as mercury (not illustrated) therein and a phosphor (not illustrated) applied on an inner surface thereof. When output voltage is applied to the electrodes from the inverter board, electrons escape from the electrodes and collide with mercury atoms in the glass tube. At this time, the mercury atoms emit ultraviolet rays, and the ultraviolet rays are converted into visible rays by the phosphor. Then, the visible rays are released outside the glass tube to emit light. The color of the emitted light can be suitably changed by adjusting the kind or the amount of the phosphors to be used. For example, the emitted light can be white or bluish-white. In FIG. 7, the cold cathode tube 25 is not illustrated.

The holder 27 is made of synthetic resin and has a white color. The holder 27 covers the end portions of the cold cathode tubes 25 and has a substantially box-shape extending along the short-side direction of the chassis 22. As illustrated in FIG. 7, the holder 27 has a stepped surface such that the diffuser plate 23a and the liquid crystal panel 11 can be placed on a front surface thereof on different levels. The holder 27 partially overlaps with the outer peripheral portion 28a of the chassis 22 such that they form a side wall of the backlight unit 12. An insertion pin 31 is provided so as to protrude from a surface of the holder 27 that faces the outer peripheral portion 28a of the chassis 22. The insertion pin 31 is inserted through an insertion hole 32 formed in the outer peripheral portion 28a of the chassis 22 to mount the holder 27 on the chassis 22.

The stepped surface of the holder 27 including a first surface 27a, a second surface 27b, and a third surface 27c in this sequence from the bottom plate 23 side so as to be parallel to the bottom surface of the chassis 22. On the first surface 27a, a short-side edge portion of the diffuser plate 23a is placed. From the first surface 27a, a cover 27d inclining toward the bottom plate surface of the chassis 22 extends. On the second surface 27b, a short-side edge portion of the liquid crystal panel 11 is placed. The third surface 27c is arranged so as to overlap with the outer peripheral portion 28a of the chassis 22 and is in contact with the bezel 13.

As illustrated in FIG. 3 and FIG. 5, the above-described color filters 19 of the liquid crystal panel 11 according to the present embodiment include the Y color portion in yellow in addition to the R, G, and B color portions in red, green, and blue, respectively, where red, green, and blue are three primary colors of light. With this configuration, the color gamut of the display image displayed by the light passed through the color portions can be expanded, and thus the display with high color reproducibility can be achieved. Further, the light passed through the Y color portions in yellow has a wavelength close to the visible peak. Namely, people perceive the light as bright light even though the light is emitted with low energy. Even when the outputs of the light sources (the cold cathode tube 25) included in the backlight unit 12 are reduced, sufficient brightness still can be achieved. Thus, the power consumption of the light sources can be reduced and the backlight unit 12 is provided with high environmental efficiency.

When the four-color-type liquid crystal panel 11 described above is used, an overall color of the display images tend to be yellowish. To solve this problem, the amounts of light passing through the R, G, B, Y color portions may be controlled by driving the TFTs 14 and the chromaticity of the display images may be corrected. An overall amount of transmitted light tends to decrease according to the correction of the chromaticity and thus the brightness may decrease. In view of such a problem, the inventor of this application has created a method for correcting the chromaticity of display images without a reduction in brightness by adjusting the chromaticity of light sources in the backlight unit 12. There are two types of light sources to be used in the backlight unit 12, i.e., an LED and a cold cathode tube. The following first comparative experiment was performed to determine brightness obtained by adjusting the chromaticity of the LED and the cold cathode tube applied in the four-color-type liquid crystal panel. The following Table 1 indicates the results thereof.

<First Comparative Experiment>

In the first comparative experiment, Comparative Examples 1, 2, and 3 and Example 1 were provided. The Comparative Example 1 is a three-color-type liquid crystal panel including R, G, and B color portions in three primary colors and LEDs as alight source. The Comparative Example 2 is a four-color-type liquid crystal panel including R, G, B, and Y color portions and LEDs in which chromaticity thereof is adjusted accordingly. The Comparative Example 3 is a three-color-type liquid crystal panel including a three-color-type liquid crystal panel as in the Comparative Example 1 and cold cathode tubes (CCT) as a light source. Example is a four-color-type liquid crystal panel including a four-color-type liquid crystal panel as in the Comparative Example 2 and cold cathode tubes in which chromaticity thereof is adjusted accordingly. The following Table 1 indicates brightness of the light source (LS Brightness), chromaticity of light source (LS Chromaticity), brightness of transmitted light exiting from the liquid crystal panel (display image) (TL Brightness), and chromaticity of the overall transmitted light (Overall Chromaticity). The LED (not illustrated) to be used in the Comparative Examples 1 and 2 includes a blue LED chip having a main light emission wavelength in a blue range. Green and red phosphors are employed as phosphors that are excited by blue light emitted from the blue LED chip to emit light. The brightness and chromaticity of the light sources and transmitted lights are obtained by measuring the light passing through the R, G, B, and Y color portions of the color filters 19 with a spectrophotometer. The chromaticity of the light source is set such that the light exiting from the liquid crystal panel becomes substantially white. Specifically, the chromaticity is set by adjusting a kind or content (composition rate) of phosphor. In the Comparative Examples and Example 1, the color portions have the same area and thickness.

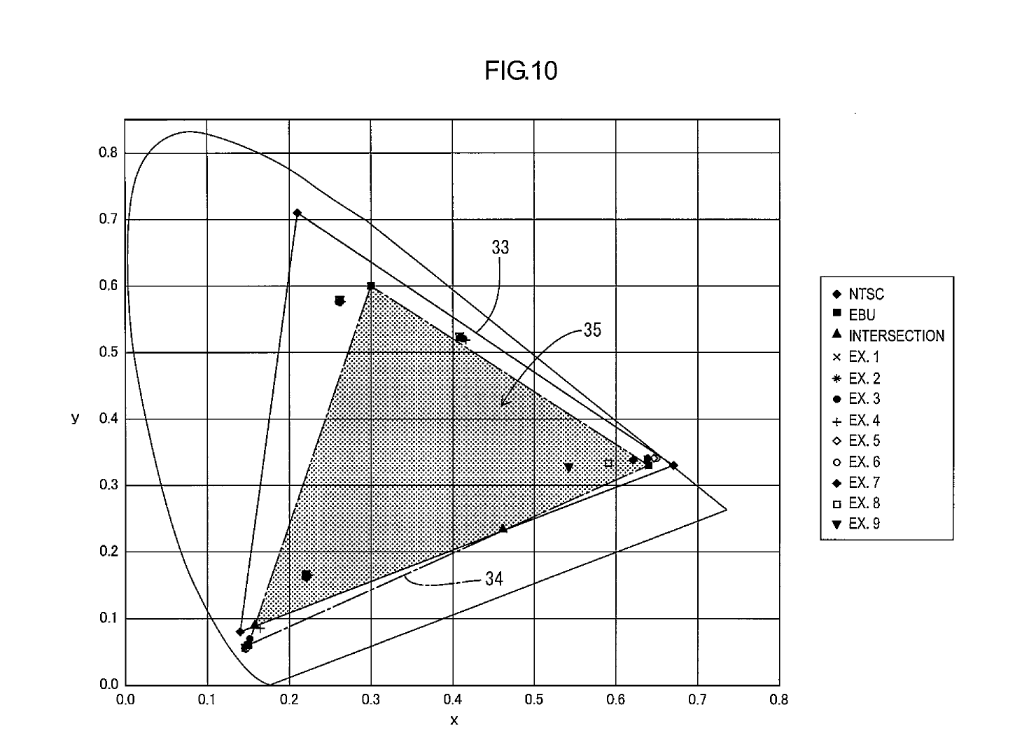

The X, Y, and Z values in Table 1 are tristimulus values of XYZ color system. The Y value is an index of the brightness. In the present embodiment, the brightness of the light source and the transmitted light is calculated based on the Y value. The brightness in the Comparative Example 2 is a relative value based on the Y value in the Comparative Example 1 that is set at 100% (a reference value). The brightness in Example 1 is a relative value based on the Y value in the Comparative Example 3 that is set at 100%. The x and y values in Table 1 are values of chromaticity coordinates in the CIE 1931 (Commission Internationale de l'Eclairage) color space chromaticity diagram illustrated in FIG. 10. The x and y values are expressed by the following formulas (1) and (2). In the present embodiment, a reference coordinate for “white” is (0.272, 0.277) on the CIE 1931 color space chromaticity diagram illustrated in FIG. 10. The chromaticity shifts to the blue side (more bluish) as x and y values becomes smaller than the reference coordinate and shifts to the yellow side (more yellowish) as x and y values becomes larger than the reference coordinate.

[formula 1]

x=X/(X+Y+Z) (1)

[formula 2]

y=Y/(X+Y+Z) (2)

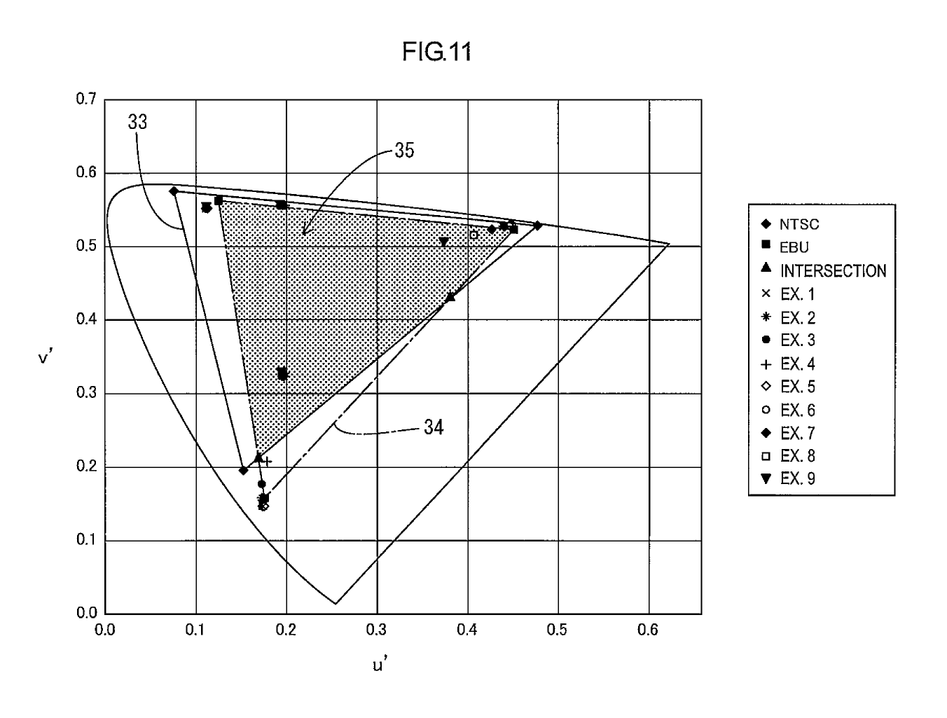

The u′ and V′ values in Table 1 are values of chromaticity coordinates on the CIE (Commission Internationale de l'Eclairage) 1976 color space chromaticity diagram illustrated in FIG. 11. The u′ and v′ values are expressed by the following formulas (1) and (2). In the present embodiment, a reference point for “white” is (0.1882, 0.4313) on the CIE 1976 color space chromaticity diagram illustrated in FIG. 11. The chromaticity shifts to the blue side (more bluish) as v′ value becomes smaller than the reference coordinate and shifts to the yellow side (more yellowish) as v′ value becomes larger than the reference coordinate.

[Formula 3]

u′=4X/(X+15Y+3Z) (3)

[Formula 4]

v′=9X/(X+15Y+3Z) (4)

TABLE 1

| | | C. EX. 1 | C. EX. 2 | C. EX. 3 | EX. 1 |
|---|---|---|---|---|---|
| LIGHT SOURCE | | LED | | CCT | |
| AREA RATIO | R | 1 | 1 | 1 | 1 |
| | Y | 0 | 1 | 0 | 1 |
| | G | 1 | 1 | 1 | 1 |
| | B | 1 | 1 | 1 | 1 |
| LS BRIGHTNESS | | 100.0% | 82.4% | 100.0% | 79.9% |
| TL BRIGHTNESS | | 100.0% | 116.1% | 100.0% | 110.1% |
| LS | x | 0.2629 | 0.22 | 0.2617 | 0.2197 |
| CHROMATICITY | y | 0.2354 | 0.1576 | 0.2351 | 0.1618 |
| | u′ | 0.1985 | 0.1977 | 0.1976 | 0.1952 |
| | v′ | 0.3998 | 0.3187 | 0.3994 | 0.3234 |
| | X | 199.6314155 | 205.5048596 | 280.8754742 | 273.8998011 |
| | Y | 178.7484934 | 147.2838353 | 252.3493731 | 201.6566495 |
| | Z | 380.8549094 | 581.4800965 | 540.1079734 | 771.0343217 |
| OVERALL | x | 0.2723 | 0.2717 | 0.272 | 0.272 |
| CHROMATICITY | y | 0.2767 | 0.2773 | 0.277 | 0.277 |
| (WH | u′ | 0.1886 | 0.1879 | 0.1882 | 0.1882 |
| CHROMATICITY) | v′ | 0.4312 | 0.4315 | 0.4313 | 0.4313 |
| | X | 8.069100104 | 9.318878202 | 11.61347443 | 12.78569034 |
| | Y | 8.19659979 | 9.514369569 | 11.82400411 | 13.0229729 |
| | Z | 13.36227678 | 15.47133225 | 19.25500041 | 21.20190876 |

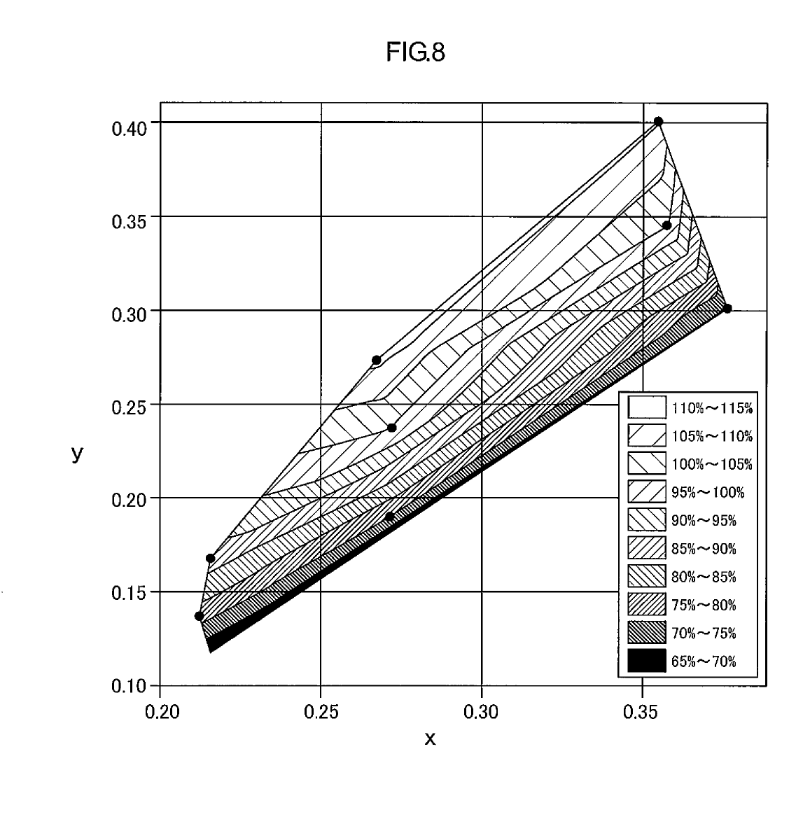

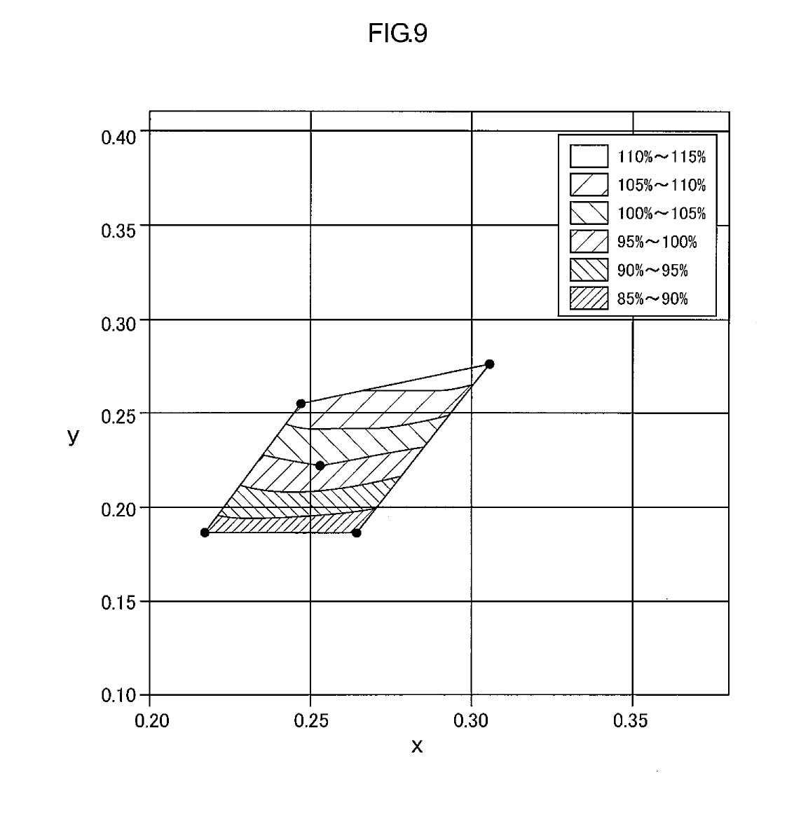

Comparisons are performed between the results relating to the Comparative Examples 1 and 2 and between the results relating to the Comparative Example 3 and Example 1 with reference to Table 1. The comparison shows that by adjusting the chromaticity of light source to alter the liquid crystal panel to the four-color-type liquid crystal panel, the brightness of the transmitted light is improved and thus the brightness is not reduced. Comparisons are also performed between the Comparative Example 2 and Example 1. The comparison shows that by adjusting the chromaticity of the light source to alter the liquid crystal panel to the four-color-type liquid crystal panel, the brightness of the cold cathode tube 25 as the light source decreases more than that of the LED and an increase rate of the brightness of the transmitted light is lowered. A possible cause of this result is that brightness is changed in the setting of the chromaticity in various ways according to kinds of light sources. In other words, chromaticity brightness characteristics differ from each other. This will be explained with reference to FIGS. 8 and 9 illustrating the chromaticity brightness characteristics of the light sources. According to the chromaticity brightness characteristic of the LED illustrated in FIG. 8, an isophote that defines an area in which the brightness is equal has an inclination sloping upwards to the right with respect to the x and y axes. Accordingly, the brightness of the LED does not decrease much even if the chromaticity is shifted to the blue side in the chromaticity adjustment. However, according to the chromaticity brightness characteristic of the cold cathode tube 25 illustrated in FIG. 9, an isophote is substantially parallel to the x axis. Accordingly, the brightness of the cold cathode tube 25 decreases more than the LED, when the chromaticity is shifted to the blue side in the chromaticity adjustment. This may vary the increase rate of the brightness in the transmitted light. Another possible cause is that the optical characteristic of the cold cathode tube 25 is not so compatible with the four-color-type liquid crystal panel compared with the LED. As a result, the brightness of the transmitted light may become relatively low. Values (%) indicated in legends in FIG. 8 and FIG. 9 are relative brightness values.

The present embodiment employs the cold cathode tube 25 as a light source, because the cold cathode tube 25 is advantageous in terms of the production cost compared with the LED. The inventor of the present invention has conducted further study and has created a method in which the reduction in brightness of the transmitted light is less likely to occur even when the cold cathode tube 25 is used as the light source. The method will be explained below. The inventor of the present invention intends to increase the amount of blue light in the transmitted light passed through the R, G, B, and Y color portions by adjusting the chromaticity of the R, G, B, and Y color portions included in the color filters 19. This reduces the amount of the chromaticity of the cold cathode tube 25 that shifts to the blue side in the chromaticity adjustment thereof. As a result, the reduction in brightness of the cold cathode tube 25 that may be caused by the chromaticity brightness characteristics is less likely to occur, and the overall amount of the light increases by the increased amount of the blue light in the light passing through the R, G, B, and Y color portions. Thus, the overall brightness of the transmitted light can be improved.

Specifically, the color filters 19 according to the present embodiment are configured such that a chromaticity of blue in the transmitted light that is emitted from the cold cathode tube 25 and passed through the R, G, B, and Y portions of the color filters 19 is outside the common gamut 35 on the CIE 1931 color space chromaticity diagram illustrated in FIG. 10 and the CIE 1976 color space chromaticity diagram illustrated in FIG. 11. The common gamut 35 is a region shared by NTSC color gamut 33 corresponding to NTSC (National Television System Committee) standard and EBU color gamut 34 corresponding to EBU (European Broadcasting Union) standard. The NTSC color gamut 33, the EBU color gamut 34, and the common gamut 35 are defined by coordinates in Table 2 below and will be explained in detail later. In the present embodiment, the following second comparative experiment was performed to demonstrate the effects obtained by the above configuration. In the second comparative experiment, the chromaticity of the color filters 19, i.e., the thicknesses of the R, G, B, and Y color portions were changed to see how the brightness and chromaticity of the transmitted light is changed. The results thereof are indicated in Table 3 below. The X, Y, Z, x, y, u′, and v′ values indicated in Table 2 and Table 3 are the same as those in Table 1. In FIG. 10 and FIG. 11, the NTSC color gamut 33 is indicated with a solid line, the EBU color gamut 34 is indicated with a one-dot chain line, and the common gamut 35 is indicated by hatching.

The NTSC color gamut 33, the EBU color gamut 34, and the common gamut 35 will be explained in detail. The NTSC color gamut 33 is defined by the chromaticity coordinates in Table 2. On the CIE 1931 color space chromaticity diagram illustrated in FIG. 10, the NTSC color gamut 33 is in a triangle defined by three points of (x, y): a primary color point for blue (0.14, 0.08); a primary color point for green (0.21, 0.71); and a primary color for red (0.67, 0.33). The EBU color gamut 34 is defined by the chromaticity coordinates in Table 2. On the CIE 1931 color space chromaticity diagram illustrated in FIG. 11, the EBU color gamut 34 is in a triangle defined by three points of (u′, v′): a primary color point for green (0.1250, 0.5625); a primary color point for blue (0.1754, 0.1879); and a primary color point for red (0.4507, 0.5229).

The common gamut 35 is a region in a square defined by an overlapped portion of two triangles of the NTSC color gamut 33 and the EBU color gamut 34. The common gamut 35 is included in both of the NTSC standard and the EBU standard, the common gamut is important to maintain the display quality (color reproducibility) of the display image. Specifically, on the CIE 1931 color space chromaticity diagram in FIG. 10, the common gamut 35 is a region in a square defined by four points of (x, y): (0.1579, 0.0884), (0.3, 0.6), (0.4616, 0.2317), and (0.64, 0.33). The point (0.1579, 0.0884) is an intersection between a line connecting the primary color point for red and the primary color point for blue in the NTSC color gamut 33 (RB line) and a line connecting the primary color point for blue and the primary color point for green in the EBU color gamut (BG line). The point (0.4616, 0.2317) is an intersection between the RB line in the NTSC color gamut 33 and the RB line in the EBU color gamut 34. On the CIE 1976 color space chromaticity diagram, the common gamut 35 is a region in a square defined by four points of (u′, v′): (0.125, 0.5625), (0.1686, 0.2125), (0.3801, 0.4293), and (0.4507, 0.5229). The point (0.1686, 0.2125) is an intersection between the RB line in the NTSC color gamut 33 and the BG line in the EBU color gamut 34. The point (0.3801, 0.4293) is an intersection between the RB line in the NTSC color gamut 33 and the BG line in the EBU color gamut 34.

TABLE 2

| | | CIE1931 | | CIE1976 | |
|---|---|---|---|---|---|
| | | COORDINATES | | COORDINATES | |
| | | x | y | u′ | v′ |
| NTSC | R | 0.6700 | 0.3300 | 0.4769 | 0.5285 |
| | G | 0.2100 | 0.7100 | 0.0757 | 0.5757 |
| | B | 0.1400 | 0.0800 | 0.1522 | 0.1957 |
| EBU | R | 0.6400 | 0.3300 | 0.4507 | 0.5229 |
| | G | 0.3000 | 0.6000 | 0.1250 | 0.5625 |
| | B | 0.1500 | 0.0600 | 0.1754 | 0.1579 |
| INTERSECTION | RB LINE- | 0.4616 | 0.2317 | 0.3801 | 0.4293 |
| B/W NTSC AND | RB LINE | | | | |
| EBU | RB LINE- | 0.1579 | 0.0884 | 0.1686 | 0.2125 |
| | BG LINE | | | | |

<Second Comparative Experiment>

In the second comparative experiment, Examples 1 to 9 were provided. Example 1 includes the R, G, B, and Y color portions having the same thickness. Examples 2 to 4 include the B color portion in blue that has a smaller thickness than the R, G, and Y color portions. Examples 5 and 6 include the R color portion in red that has a larger thickness than the G, B, and Y color portions. Examples 7 to 9 include the r color portion in red that has a smaller thickness than the G, B, and Y color portions. The Comparative Example 3 is the same as in the above first comparative experiment. The following Table 3 indicates the thickness of the R, G, B, and Y color portions, brightness of the transmitted light exiting from the liquid crystal panel (the display image) (TL brightness), NTSC ratios of the color gamut of the transmitted light, chromaticity of the cold cathode tube (CCT Chromaticity), and chromaticity of each color relating to the transmitted light, of the Comparative Example 3 and Examples 1 to 9.

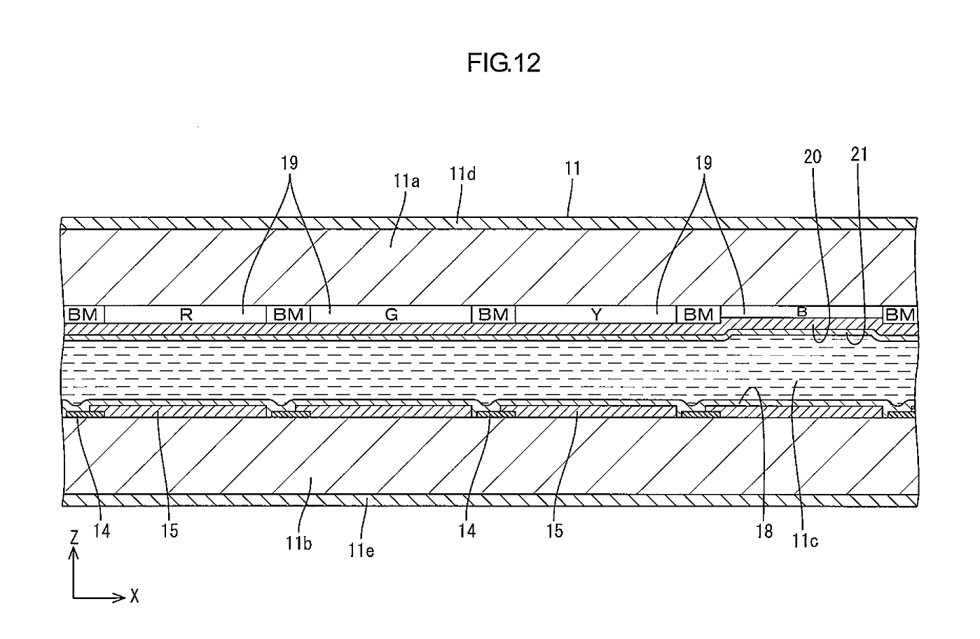

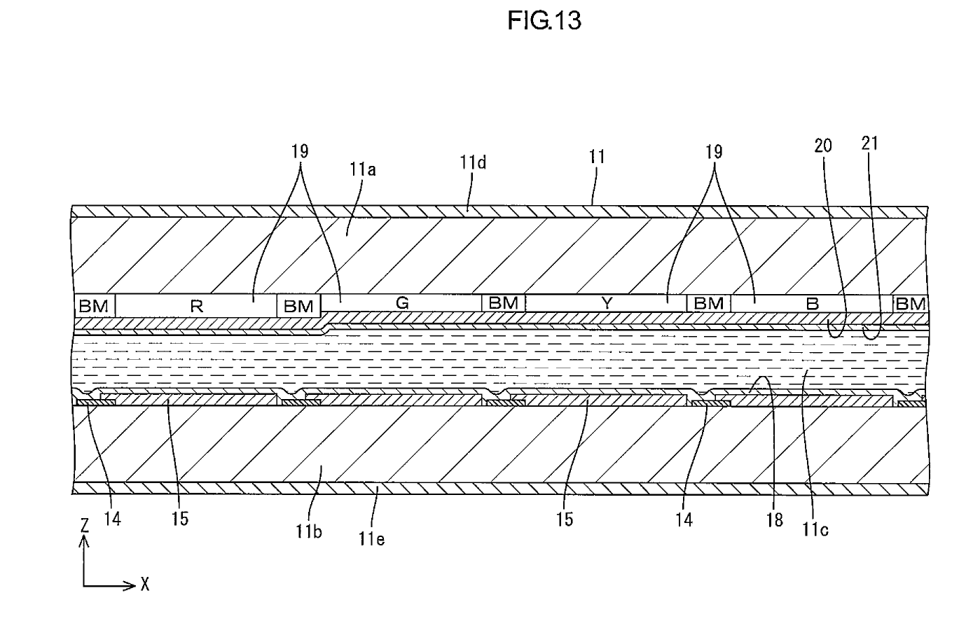

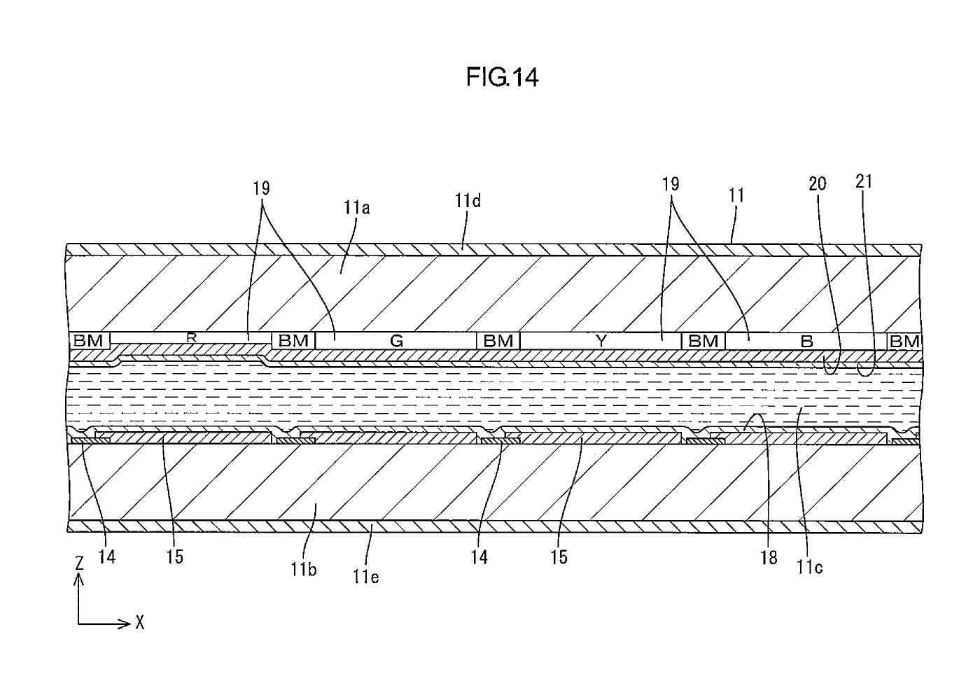

As illustrated in FIG. 3, each of the R, G, B, and Y color portions in Example 1 has the thickness of 2.1 μm (refer to Table 3 for the thickness). As illustrated in FIG. 12, in Examples 2 to 4, the B color portion in blue has a smaller thickness than the R, G, and Y color portions. Specifically, the B color portion in blue in Example 2 has the thickness of 1.8 μm that is about 85.7% of the thickness (relative value) of the R, G, and Y color portions (having the same thickness of 2.1 μm). The B color portion in blue in Example 3 has the thickness of 1.5 μm that is about 57.1% of the thickness of the R, G, and Y color portions. Namely, the B color portion in blue in Examples 2 to 4 has the thickness in a range of 57.1% to 85.8% of the thickness of the R, G, and Y color portions. As illustrated in FIG. 13, the R color portion in red in Examples 5 and 6 has a larger thickness than the G, B, and Y color portions. Specifically, the R color portion in red in Example 5 has the thickness of 2.3 μm that is about 109.5% of the G, B, and Y color portions (having the same thickness of 2.1 μm). The R color portion in red in Example 6 has the thickness of 2.5 μm that is about 119.0% of the thickness of the G, B, and Y color portions. As illustrated in FIG. 14, the R color portion in red in Examples 7 to 9 has the thickness of 1.8 μm that is about 85.7% of the thickness of the G, B, and Y color portions (having the same size of 2.1 μm). The R color portion in red in Example 8 has the thickness of 1.5 μm that is about 71.4% of the thickness of the color portions G, B, and Y color portions. The R color portion in red in Example 9 has the thickness of 1.2 μm that is about 57.1% of the thickness of the G, B, and Y color portions. Namely, the R color portion in red in Examples 7 to 9 has the thickness in a range of 57.1% to 85.8% of the thickness of the G, B, and Y color portions.

In Table 3, the NTSC ratio of the color gamut of the transmitted light is an area ratio of the color gamut of the transmitted light in the Comparative Example 3 and Examples to the NTSC color gamut 33. The NTSC ratio of 70% or higher indicates that color reproducibility that is sufficient for a viewer to view the liquid crystal display device 10 is obtained, that is, the sufficient display quality is achieved. The EBU color gamut 34 has the NTSC ratio of 72%. Thus, the transmitted light having a color gamut of 72% or higher can have the color gamut corresponding to the EBU standard or better color gamut, and thus higher display quality can be achieved. The brightness and chromaticity of the light sources and the transmitted light are obtained by measuring the light passing through the R, G, B, and Y color portions of the color filters 19 with a spectrophotometer. The R, G, B, and Y color portions in Examples have the same pigment concentration. Thus, the chromaticity of the R, G, B, and Y color portions vary according to the thickness thereof. Along with the decrease in the thickness of the R, G, B, and Y color portions, the amount of light passing through the color portions increases, although the chromatic purity decreases and color gamut becomes smaller. Along with the increase in the thickness of the color portions, the chromatic purity tends to be improved and the color gamut is expanded, although the amount of light passing through the color portions decreases. In other words, the smaller the thickness of the R, G, B, and Y color portions is, the higher the brightness and the lower the chromatic reproducibility become. Conversely, the larger the thickness of the color portions is, the higher the chromatic reproducibility and the lower the brightness becomes. Similar in the first comparative experiment, the brightness of the transmitted light is calculated based on the Y value. In the second comparative experiment, like the above-described first comparative experiment, the brightness of Examples 1 to 9 are represented with relative values based on the Y value in the Comparative Example 3 that is set at 100%. The chromaticity of the cold cathode tube 25 is set by adjusting kind or content of the phosphors to be used like in the first comparative experiment.

TABLE 3

| | | C. EX. 3 | EX. 1 | EX. 2 | EX. 3 | EX. 4 |
|---|---|---|---|---|---|---|
| AREA | R | 1 | 1 | 1 | 1 | 1 |
| RATIO | Y | 0 | 1 | 1 | 1 | 1 |
| | G | 1 | 1 | 1 | 1 | 1 |
| | B | 1 | 1 | 1 | 1 | 1 |
| THICKNESS | R | 2.1 | 2.1 | 2.1 | 2.1 | 2.1 |
| (μm) | Y | — | 2.1 | 2.1 | 2.1 | 2.1 |
| | G | 2.1 | 2.1 | 2.1 | 2.1 | 2.1 |
| | B | 2.1 | 2.1 | 1.8 | 1.5 | 1.2 |
| TL | | 100.0% | 110.1% | 111.9% | 113.8% | 115.9% |
| BRIGHTNESS | | | | | | |
| NTSC RATIO | | 72.1% | 75.2% | 74.5% | 73.1% | 70.2% |
| (CIE1931) | | | | | | |
| NTSC RATIO | | 82.6% | 90.5% | 88.0% | 84.0% | 77.1% |
| (CIE1976) | | | | | | |
| CCT | x | 0.2617 | 0.2197 | 0.2211 | 0.2225 | 0.2237 |
| CHROMATICITY | y | 0.2351 | 0.1618 | 0.1633 | 0.1644 | 0.1648 |
| | u′ | 0.1976 | 0.1952 | 0.1958 | 0.1966 | 0.1975 |
| | v′ | 0.3994 | 0.3234 | 0.3253 | 0.3268 | 0.3274 |
| | X | 280.8755 | 273.8998 | 273.9821 | 274.0038 | 273.886 |
| | Y | 252.3494 | 201.6566 | 202.3099 | 202.535 | 201.7817 |
| | Z | 540.108 | 771.0343 | 762.6882 | 755.1669 | 748.6339 |
| OVERALL | x | 0.272 | 0.272 | 0.272 | 0.272 | 0.272 |
| CHROMATICITY | y | 0.277 | 0.277 | 0.277 | 0.277 | 0.277 |
| (WH CHROMATICITY) | u′ | 0.1882 | 0.1882 | 0.1882 | 0.1882 | 0.1882 |
| | v′ | 0.4313 | 0.4313 | 0.4313 | 0.4313 | 0.4313 |
| | X | 11.61347 | 12.78569 | 12.9905 | 13.20837 | 13.4508 |
| | Y | 11.824 | 13.02297 | 13.2265 | 13.45545 | 13.70142 |
| | Z | 19.255 | 21.20191 | 21.53862 | 21.90512 | 22.30554 |
| RED | x | 0.6426 | 0.6374 | 0.638 | 0.6385 | 0.6392 |
| CHROMATICITY | y | 0.3452 | 0.3403 | 0.3404 | 0.3403 | 0.3402 |
| | u′ | 0.4388 | 0.4389 | 0.4393 | 0.4398 | 0.4405 |
| | v′ | 0.5304 | 0.5273 | 0.5274 | 0.5275 | 0.5275 |
| | X | 4.671629 | 2.628153 | 2.671422 | 2.713996 | 2.760318 |
| | Y | 2.509938 | 1.40325 | 1.425302 | 1.44663 | 1.468953 |
| | Z | 0.08882 | 0.091665 | 0.09075 | 0.089913 | 0.089154 |
| YELLOW | x | — | 0.4097 | 0.4114 | 0.4133 | 0.4159 |
| CHROMATICITY | y | — | 0.5222 | 0.5215 | 0.5204 | 0.5186 |
| | u′ | — | 0.194 | 0.1951 | 0.1964 | 0.1983 |
| | v′ | — | 0.5564 | 0.5564 | 0.5564 | 0.5562 |
| | X | — | 4.476967 | 4.527391 | 4.570411 | 4.601457 |
| | Y | — | 5.706235 | 5.738139 | 5.754717 | 5.737341 |
| | Z | — | 0.744512 | 0.738622 | 0.732501 | 0.725059 |
| GREEN | x | 0.2845 | 0.261 | 0.2621 | 0.263 | 0.2638 |
| CHROMATICITY | y | 0.6048 | 0.5761 | 0.5766 | 0.5769 | 0.5764 |
| | u′ | 0.1175 | 0.1112 | 0.1116 | 0.112 | 0.1124 |
| | v′ | 0.5618 | 0.5521 | 0.5524 | 0.5525 | 0.5525 |
| | X | 3.645541 | 1.997365 | 2.00755 | 2.011652 | 2.001967 |
| | Y | 7.749565 | 4.40793 | 4.416968 | 4.412244 | 4.374555 |
| | Z | 1.418922 | 1.246074 | 1.235565 | 1.224871 | 1.212389 |
| BLUE | x | 0.1464 | 0.1462 | 0.1478 | 0.1521 | 0.1646 |
| CHROMATICITY | y | 0.0683 | 0.055 | 0.0604 | 0.0693 | 0.0853 |
| | u′ | 0.166 | 0.1737 | 0.1724 | 0.1725 | 0.1782 |
| | v′ | 0.1743 | 0.147 | 0.1585 | 0.1768 | 0.2078 |
| | X | 3.300745 | 3.491743 | 3.62722 | 3.870454 | 4.440184 |
| | Y | 1.540624 | 1.312975 | 1.482416 | 1.763143 | 2.301975 |
| | Z | 17.7066 | 19.07912 | 19.43342 | 19.81792 | 20.23964 |
| | | EX. 5 | EX. 6 | EX. 7 | EX. 8 | EX. 9 |
| AREA | R | 1 | 1 | 1 | 1 | 1 |
| RATIO | Y | 1 | 1 | 1 | 1 | 1 |
| | G | 1 | 1 | 1 | 1 | 1 |
| | B | 1 | 1 | 1 | 1 | 1 |
| THICKNESS | R | 2.3 | 2.5 | 1.8 | 1.5 | 1.2 |
| (μm) | Y | 2.1 | 2.1 | 2.1 | 2.1 | 2.1 |
| | G | 2.1 | 2.1 | 2.1 | 2.1 | 2.1 |
| | B | 2.1 | 2.1 | 2.1 | 2.1 | 2.1 |
| TL | | 109.6% | 109.2% | 111.1% | 112.6% | 115.3% |
| BRIGHTNESS | | | | | | |
| NTSC RATIO | | 76.2% | 76.8% | 73.0% | 69.0% | 62.6% |
| (CIE1931) | | | | | | |
| NTSC RATIO | | 92.0% | 93.1% | 87.2% | 81.7% | 72.5% |
| (CIE1976) | | | | | | |
| CCT | x | 0.2199 | 0.2202 | 0.2196 | 0.2198 | 0.2207 |
| CHROMATICITY | y | 0.1617 | 0.1617 | 0.162 | 0.163 | 0.165 |
| | u′ | 0.1954 | 0.1957 | 0.195 | 0.1947 | 0.1945 |
| | v′ | 0.3234 | 0.3234 | 0.3237 | 0.3248 | 0.3272 |
| | X | 273.8514 | 273.8242 | 273.9718 | 274.1241 | 274.3861 |
| | Y | 201.3311 | 201.1543 | 202.1532 | 203.226 | 205.1035 |
| | Z | 769.9545 | 768.7717 | 771.3742 | 769.7611 | 763.7992 |
| OVERALL | x | 0.272 | 0.272 | 0.272 | 0.272 | 0.272 |
| CHROMATICITY | y | 0.277 | 0.277 | 0.277 | 0.277 | 0.277 |
| (WH CHROMATICITY) | u′ | 0.1882 | 0.1882 | 0.1882 | 0.1882 | 0.1882 |
| | v′ | 0.4313 | 0.4313 | 0.4313 | 0.4313 | 0.4313 |
| | X | 12.73147 | 12.68711 | 12.89841 | 13.07752 | 13.38553 |
| | Y | 12.96237 | 12.91723 | 13.13081 | 13.31415 | 13.62887 |
| | Z | 21.10723 | 21.03341 | 21.38285 | 21.67973 | 22.19282 |
| RED | x | 0.6444 | 0.6492 | 0.6206 | 0.5909 | 0.5423 |
| CHROMATICITY | y | 0.3408 | 0.3407 | 0.3381 | 0.3332 | 0.3249 |
| | u′ | 0.4444 | 0.4485 | 0.4268 | 0.4064 | 0.3731 |
| | v′ | 0.5288 | 0.5296 | 0.5232 | 0.5156 | 0.5029 |
| | X | 2.588131 | 2.552557 | 2.711068 | 2.832213 | 3.03531 |
| | Y | 1.368734 | 1.339785 | 1.477115 | 1.59674 | 1.818368 |
| | Z | 0.059587 | 0.039684 | 0.180414 | 0.363846 | 0.742917 |
| YELLOW | x | 0.4103 | 0.4108 | 0.4091 | 0.4085 | 0.4084 |
| CHROMATICITY | y | 0.5217 | 0.5213 | 0.5228 | 0.5236 | 0.5245 |
| | u′ | 0.1945 | 0.1948 | 0.1935 | 0.193 | 0.1927 |
| | v′ | 0.5563 | 0.5563 | 0.5565 | 0.5566 | 0.5568 |
| | X | 4.480759 | 4.486112 | 4.478398 | 4.494449 | 4.539867 |
| | Y | 5.69663 | 5.692132 | 5.722455 | 5.760318 | 5.830357 |
| | Z | 0.742832 | 0.741394 | 0.745923 | 0.746904 | 0.745856 |
| GREEN | x | 0.2612 | 0.2613 | 0.261 | 0.2612 | 0.262 |
| CHROMATICITY | y | 0.5759 | 0.5758 | 0.5764 | 0.5771 | 0.5784 |
| | u′ | 0.1113 | 0.1113 | 0.1111 | 0.1111 | 0.1113 |
| | v′ | 0.5521 | 0.5521 | 0.5522 | 0.5524 | 0.5528 |
| | X | 1.992957 | 1.99064 | 2.004255 | 2.019439 | 2.046414 |
| | Y | 4.394584 | 4.386331 | 4.426079 | 4.46133 | 4.517727 |
| | Z | 1.243334 | 1.240938 | 1.248262 | 1.249416 | 1.246657 |
| BLUE | x | 0.1462 | 0.1462 | 0.1462 | 0.1462 | 0.1462 |
| CHROMATICITY | y | 0.0549 | 0.0549 | 0.055 | 0.0552 | 0.0555 |
| | u′ | 0.1737 | 0.1737 | 0.1737 | 0.1735 | 0.1733 |
| | v′ | 0.1468 | 0.1468 | 0.147 | 0.1474 | 0.1481 |
| | X | 3.486838 | 3.481514 | 3.493396 | 3.486499 | 3.460432 |
| | Y | 1.31014 | 1.307706 | 1.315339 | 1.316924 | 1.314992 |
| | Z | 19.05213 | 19.02253 | 19.08752 | 19.04685 | 18.89702 |

The chromaticity of blue (primary color point for blue) in the transmitted light in Examples 1 to 9 indicated in Table 3 is outside the common gamut 35 in the color space chromaticity diagrams illustrated in FIG. 10 and FIG. 11. The common gamut 35 is very importation in maintaining the display quality (color reproducibility) of the display image. Preferably, the color gamut of the transmitted light includes the common gamut 35 as large as possible. In Examples 1 to 9, the chromaticity of blue is outside the common gamut 35, so that the color gamut of the transmitted light includes a large part or whole of the common gamut 35. As a result, sufficient color reproducibility for viewing the liquid crystal display device 10 can be achieved. The term “color gamut of the transmitted light” used herein is a region in a square defined by four points of chromaticity (primary color points) of red, blue, yellow, and green in the transmitted light of Examples 1 to 9. In the setting of the color filters 19, the color gamut narrows (color reproducibility is lowered) and the amount of blue light increases as the chromaticity of blue in the transmitted light is closer to the common gamut 35 in the outside of the common gamut 35. Specifically, comparing Examples 1 to 4 with respect to the chromaticity of blue in the transmitted light, Example 4 is closest to the common gamut 35, followed by Example 3, Example 2, and Example 1 (in the order of thickness). Comparing Example 1 that has a chromaticity of blue that is farthest from the common gamut 35 and Example 4 that has a chromaticity of blue that is nearest to the common gamut 35, Example 4 has a lower NTSC ratio and a larger Y value of chromaticity of blue than Example 1. Thus, when the chromaticity of cold cathode tube 25 is adjusted for the four-color-type liquid crystal panel 11, the chromaticity does not need to be adjusted to be bluish. Specifically, comparing Example 1 and Example 4 with respect to the chromaticity of the cold cathode tube 25 in Table 3, the chromaticity of Example 4 is yellowish than that of Example 1 (see the x value, y value, and v′ value of the chromaticity of the cold cathode tube 25). Accordingly, the reduction in the brightness of the cold cathode tube 25 due to the chromaticity adjustment is less likely to occur. As a result, the brightness of the transmitted light can be maintained at a high level. In addition, an overall amount of the transmitted light (Y value of chromaticity of overall transmitted light in Table 3) increases along with the increase of the amount of transmitted light (Y value of chromaticity of blue in Table 3), and thus the reduction in brightness of the cold cathode tube 25 is less likely to occur and the brightness of the transmitted light is improved. Specifically, in Table 3, Example 4 has the highest brightness of the transmitted light, followed by Example 3, Example 2, and Example 1.

The chromaticity of blue in Examples 2 to 4 has y and v′ values each larger than that of Example 1. Specifically, the y value is larger than 0.055 and the v′ value is larger than 0.147. Accordingly, the color gamut of blue in the transmitted light narrows in Examples 2 to 4 while the amount of blue light is larger than that of Example 1. Thus, the brightness of the transmitted light is higher than Example 1. Examples 2 to 4 differ from Example 1 in that the B color portion in blue has a thickness smaller than that of R, G, and Y color portions, and thus Examples 2 to 4 have the y and v′ value each larger than Example 1. That is, by having the B color portion in blue that has the thickness smaller than that of the R, G, and Y color portions, the amount of transmitted light in blue can be increased, and thus the brightness of the transmitted light can be improved. More specifically described, the transmitted light of Example 4 has the largest brightness, followed by Example 3 and Example 2. The transmitted light tends to have more improved brightness as the thickness of the B color portion in blue becomes smaller. However, if the ratio of the thickness of the B color portion in blue with respect to the thickness of the R, G, and Y color portions is less than 50%, a defect may occur in capacitance between the substrates 11a, 11b of the liquid crystal panel 11. As illustrated in FIG. 3 and FIG. 12, the liquid crystal panel 11 includes a liquid crystal layer 11c between the pair of transparent glass substrates 11a, 11b. The size of the capacitance between the substrates 11a, 11b is important in the control of an alignment of liquid crystal molecules included in the liquid crystal layer 11c. If the ratio of the thickness is less than 50%, the difference in the capacitance of the B color portion in blue and that of the R, G, and Y color portions may be too big, and thus the liquid crystal molecules or the light transmission rate may not be sufficiently controlled. On the other hand, if the ratio of the thickness is 90% or higher, the amount of the blue light in the transmitted light only slightly increases, and thus sufficient effect may not be obtained. In Examples 2 to 4, the ratio of the thickness is adjusted to be within a range of 57.1 to 85.8%, the alignment of liquid crystal molecules can be easily controlled by an application of electric field, and thus a circuit design relating to the liquid crystal 11 panel can be simplified.

As illustrated in FIG. 10 and FIG. 11, among Examples 2 to 4, the chromaticity of blue in Example 4 is set so as to be outside the common gamut 35 and inside the EBU color gamut 34. The chromaticity of blue in Example 4 is closer to the common gamut 35, i.e., shifted to the yellow side, than Examples 1 to 3 in which the chromaticity of blue is set outside the EBU color gamut 34. Accordingly, the amount of blue light in the transmitted light (Y value of chromaticity of blue in Table 3) in Example 4 is larger than that in Examples 1 to 3. As a result, the brightness of the transmitted light can be improved. Conversely, the chromaticity of blue in Example 1 to 3 that is set outside the common gamut 35 and the EBU color gamut is further from the common gamut 35, i.e., shifted to the blue side, than Example 4 in which the chromaticity of blue is inside the EBU color gamut 34. Accordingly, Examples 1 to 3 each have a broader color gamut of blue than Example 4 and have 72% or higher in the NTSC ratio. Thus, high color reproducibility is obtained.

Examples 5 and 6 are different from Example 1 in that the R color portion in red has a larger thickness than the B, G, and Y color portions. As illustrated in FIG. 10 and FIG. 11, the chromaticity of red in the transmitted light in Examples 5 and 6 is inside the NTSC gamut 33 and outside the common gamut 35, and is further from the common gamut 35 than Example 1. The other primary color points (chromaticity of blue, green, and yellow) in Examples 5 and 6 are the same as in Example 1. Accordingly, the color gamut of the transmitted light in Example 5 and 6 has a more expanded color gamut of red and a larger NTSC ratio than Example 1. Thus, high color reproducibility is obtained. More specifically described, Example 6 has a larger NTSC ratio than that of Example 5. This indicates that the color reproducibility tends to be improved as the thickness increases.

Examples 7 to 9 are different from Example 1 in that the R color portion in red has a thickness smaller than that of the B, G, and Y color portions. As illustrated in FIG. 10 and FIG. 11, Examples 7 to 9 have the chromaticity of red in the transmitted light that is inside the common gamut 35 and have a smaller color gamut of red than that of Example 1 in which the chromaticity of red is outside the common gamut 35. However, the brightness of the transmitted light is higher in Example 7 to 9 than in Example 1. Example 9 has the highest brightness, followed by Example 8 and Example 7. The brightness of the transmitted light tends to increase as the thickness of the R color portion in red is smaller. This may be based on that the amount of red light in the transmitted light increases as thickness of the R color portion in red is smaller. Example 7 among Examples 7 to 9 has NTSC ratio of 72% or higher, and thus high brightness can be obtained while the color reproducibility is taken into consideration.

As illustrated in FIG. 10 and FIG. 11, Examples 1 to 9 have the chromaticity of green and the chromaticity of yellow that are outside the common gamut 35. Compared to the case where the chromaticity of green and the chromaticity of yellow are inside the common gamut 35, the color gamut of green and the color gamut of yellow are expanded, and thus high color reproducibility can be obtained.

As described above, the display device 10 according to the present embodiment includes: a display panel 11c including a pair of substrates 11a, 11b, a substance having optical characteristics varying according to an application of electric field and arranged between the substrates, and color filters 19 formed on one of the substrates, the color filter including R, G, B, and Y color portions in red, green, blue and yellow, respectively; and a backlight unit 12 configured to illuminate the display panel 11, the lighting unit including cold cathode tubes 25 as light sources. The color filters 19 are configured such that a chromaticity of blue in transmitted light that is emitted from the cold cathode tubes and passed through the R, G, B, and Y color portions included in the color filters 19 is outside a common gamut 35 on both of the CIE 1931 color space chromaticity diagram and the CIE 1976 color space chromaticity diagram. The common gamut is a region shared by NTSC color gamut corresponding to NTSC standard and EBU color gamut corresponding to EBU standard.

The color filters 19 including the color portion in yellow in addition to the R, G, and B color portions in red, green and blue that are three primary colors of light are formed on one of the substrates 11a, 11b of the display panel 11. With this configuration, a color reproduction range, colors in which are perceivable to human eyes, can be expanded, that is, the color gamut can be expanded. Furthermore, reproducibility of colors of objects in nature can be enhanced and thus display quality can be improved. Light exiting from the Y color portion in yellow among the R, G, B, and Y color portions of the color filters 19 has a wavelength close to the visible peak. Namely, people perceive the light as bright light even though the light is emitted with low energy. Even when the outputs of the light sources are reduced, sufficient brightness still can be achieved. Therefore, the power consumption of the light sources can be reduced and the lighting unit is provided with high environmental efficiency. Because the high brightness can be achieved as described above, clear contrast can be achieved. Therefore, the display quality can be further improved.

When the Y color portion in yellow is included in the color filters 19, the overall color of light exiting from the display panel 11, that is, the overall color of the display images tend to be yellowish. To solve this problem, the amounts of light passing through the R, G, B, and Y color portions may be controlled by controlling an application of electric field and the chromaticity of the display images may be corrected. An overall amount of transmitted light tends to decrease according to the correction of the chromaticity and thus the brightness may decrease. In view of such a problem, the inventor of this application has created a method for correcting the chromaticity of display images without a reduction in brightness by adjusting the chromaticity of light sources in the backlight unit 12.

The cold cathode tubes 25 may be preferable as light sources of the backlight unit 12 in some cases to reduce the production cost. However, a further study conducted by the inventor of the present invention revealed that the cold cathode tube 25 may have lower brightness and lower transmitted light brightness than the LED. This may occur when the chromaticity of the cold cathode tubes 25 as the light sources is adjusted to be shifted to the blue side, which is a complementary color of yellow, in order to correct the chromaticity of display images. This problem may be caused by chromaticity and brightness characteristics of the cold cathode tube 25 and compatibility of optical characteristics with the liquid crystal display panel 11 including the Y color portion in yellow.

To solve such a problem, in the present embodiment, the color filters 19 are configured such that a chromaticity of blue in the transmitted light that is emitted from the cold cathode tube 25 and passed through the R, G, B, and Y color portions of the color filters 19 is outside the common gamut 35 on both of the CIE 1931 color space chromaticity diagram and the CIE 1976 color space chromaticity diagram. The common gamut 35 is a region shared by the NTSC color gamut 33 corresponding to NTSC standard and the EBU color gamut 34 corresponding to EBU standard. With this configuration, the color gamut of blue in the transmitted light can include the substantially entire of the common gamut 35, and thus sufficient color reproducibility can be achieved. In addition, in the setting of the color filters 19, although the color reproducibility is lowered, the amount of blue light in the transmitted light can be increased as the chromaticity of blue in the transmitted light is closer to the common gamut in the outside of the common gamut. Accordingly, in the adjustment of chromaticity of the cold cathode tube 25, the chromaticity does not need to be adjusted to be bluish. In addition, overall amount of the transmitted light increases, and thus the brightness of the transmitted light can be improved. As a result, the reduction in brightness of the cold cathode tube 25 due to the chromaticity adjustment is less likely to occur, and high brightness of the transmitted light can be maintained. As described above, according to the present embodiment, high brightness of the transmitted light can be maintained while sufficient color reproducibility is obtained.

The color filters 19 are configured such that the chromaticity of blue in the transmitted light is inside the EBU color gamut 34 on both of the CIE 1931 color space chromaticity diagram and CIE 1976 color space chromaticity diagram. In the setting of the color filters 19, the amount of blue light in the transmitted light increases as the chromaticity of blue in the transmitted light is closer to the common gamut in the outside of the common gamut and the chromaticity of blue in the transmitted light tends to shift to the yellow side. In the color gamut of blue in the outside of the common gamut 35, a region inside the EBU color gamut 34 is relatively shifted to the yellow side and a region outside the EBU color gamut 34 is relatively shifted to the blue side. Accordingly, the amount of blue light in the transmitted light is large when the chromaticity of blue in the transmitted light is set to be outside the common gamut 35 and the inside the EBU color gamut 34 compared with the chromaticity of blue that is set to be outside the common gamut 35 and outside the EBU color gamut 34. With this configuration, the brightness of the cold cathode tube 25 is less likely to be reduced in the adjustment of the chromaticity of the cold cathode tube 25, and thus the brightness of the transmitted light can be increased.

The color filters 19 are configured such that the chromaticity of blue in the transmitted light is outside the EBU color gamut 34 on both of the CIE 1931 color space chromaticity diagram and the CIE 1976 color space chromaticity diagram. In the setting of the color filters 19, the color gamut of blue in the transmitted light is expanded and the chromaticity of blue in the transmitted light tends to be shifted to the blue side as the chromaticity of blue is set further from the common gamut 35. In the color gamut of blue in the outside of the common gamut 35, a region inside the EBU color gamut 34 is relatively shifted to the yellow side and a region outside the EBU color gamut is relatively shifted to the blue side. Accordingly, the color gamut of blue in the transmitted light become larger when the chromaticity of blue in the transmitted light is set to be outside the common gamut 35 and outside the EBU color gamut 34 compared with the chromaticity of blue that is set to be outside the common gamut 35 and inside the EBU color gamut 34. Accordingly, high color reproducibility can be achieved.

The color filters 19 are configured such that the chromaticity of blue in the transmitted light has a y value of 0.055 or larger on the CIE 1931 color space chromaticity diagram. With this configuration, the amount of blue light in the transmitted light tends to increase as the y value is larger than 0.055 (or is closer to the common gamut) on the CIE 1976 color space chromaticity diagram, and thus the reduction in brightness of the cold cathode tube 25 that may occur in the chromaticity adjustment of the cold cathode tube 25 is less likely to occur and the brightness of the transmitted light can be improved. The y value that is 0.055 on the CIE 1931 color space chromaticity diagram is outside the NTSC color gamut 33 and the EBU color gamut 34.

The color filters 19 are configured such that the chromaticity of blue in the transmitted light has a v′ value of 0.147 or larger on the CIE 1976 color space chromaticity diagram. With this configuration, the amount of blue light in the transmitted light tends to increase as the v′ value is larger than 0.147 (or is closer to the common gamut) on the CIE 1976 color space chromaticity diagram. Accordingly, the reduction in brightness of the cold cathode tube 25 that may occur in the chromaticity adjustment of the cold cathode tube 25 is less likely to occur. The coordinate in which the v′ value is 0.147 on the CIE 1976 color space chromaticity diagram is outside the NTSC color gamut 33 and inside the EBU color gamut 34.

The R, G, B, and Y color portions in red, green, blue, and yellow have equal areas. If the area ratio of the R, G, B, and Y color portions is varied to control the chromaticity of blue in the transmitted light, a special apparatus for producing a liquid crystal panel 11 is required. According to the present invention, four color portions of R, G, B, and Y have an equal area ratio, like the liquid crystal panel 11 including a conventional color filters having three color portions of R, G, B, and Y in red, green, and blue, and thus the same apparatus for producing the liquid crystal panel 11 having three color portions can be used. As a result, the cost for producing the liquid crystal panel 11 including the color filters 19 having four color portions of R, G, B, and Y can be sufficiently lowered.

The B color portion in blue has a smaller thickness than each of the R and G color portions in red and green. With this configuration, the amount of blue light increases compared with the case that the B, R, and G color portions in blue, red, and green have an equal thickness, although the color gamut of blue in the transmitted light decreases. As a result, the reduction in brightness of the cold cathode tube 25 that may occur in the chromaticity adjustment of the cold cathode tube is less likely to occur, and thus the brightness of the transmitted light can be improved.

The R color portion in red has a thickness substantially equal to that of the G color portion in green. With this configuration, capacitance between the substrates 11a, 11b at the R and G color portions in red and green can be equal. Thus, optical characteristics of the liquid crystal layer 11c that is the substance between the substrates 11a, 11b can be readily controlled by an application of electric field. As a result, light transmissibility with respect to the R and G color portions in red and green can be readily controlled, and thus a circuit design relating to the liquid crystal 11 panel can be simplified.

The Y color portion in yellow has a thickness equal to that of each of the R color portion in red and the G color portion in green. With this configuration, capacitance between the substrates 11a, 11b at the Y color portion in yellow, in addition to the R and G color portions in red and green, can be substantially equal. Thus, a circuit design relating to the liquid crystal panel 11 can be simplified.

The B color portion in blue has a thickness that is 50 to 90% of the thickness of each of the R color portion in red and the G color portion in green. If the B color portion in blue has a thickness that is smaller than 50% of the thickness of each of the R color portion in red and the G color portion in green, the capacitance to be formed between the substrates 11a, 11b is likely to be largely different in the R and G color portions in red and green and in the B color portion in blue. As a result, the optical characteristics of the liquid crystal layer 11c that is the substance provided between the substrates 11a, 11b may not be properly controlled by the application of electric field. On the other hand, if the B color portion in blue has a thickness that is larger than 90% of the thickness of each of the R color portion in red and the G color portion in green, the difference between the thickness of the R and G color portions in red and green and the thickness of the B color portion in blue is too small. As a result, the amount of blue light in the transmitted light increase only a little, and thus a sufficient effect may not be obtained. By setting the thickness in 50 to 90% as above, the optical characteristics of the liquid crystal layer 11c that is the substance provided between the substrates 11a, 11b can be properly controlled by the application of electric field, and the amount of blue light in the transmitted light can be sufficiently increased to sufficiently improve the brightness of the transmitted light.

The B color portion in blue has a thickness that is 57.1 to 85.8% of the thickness of each of the R color portion in red and the G color portion in green. With this configuration, the optical characteristics of the liquid crystal layer 11c that is the substance provided between the substrates 11a, 11b can be properly controlled by the application of electric field, and the amount of blue light in the transmitted light can be sufficiently increased to sufficiently improve the brightness of the transmitted light.

The R and G color portions in red and green each have a thickness of 2.1 μm and the B color portion in blue has a thickness of 1.2 to 1.8 μm. By setting the thickness of the color portions as above, the optical characteristics of the liquid crystal layer 11c that is the substance provided between the substrates 11a, 11b can be properly controlled by the application of electric field, and the amount of blue light in the transmitted light can be sufficiently increased to sufficiently improve the brightness of the transmitted light.

The color filters 19 are configured such that a chromaticity of red in the transmitted light is inside the common gamut 35 on both the CIE 1931 color space chromaticity diagram and the CIE 1976 color space chromaticity diagram. The common gamut 35 is a region shared by NTSC color gamut 33 corresponding to NTSC standard and EBU color gamut 34 corresponding to EBU standard. With this configuration, since the chromaticity of red in the transmitted light is inside the common gamut 35, the amount of red light in the transmitted light becomes large compared with the case that the chromaticity of red in the transmitted light is outside the common gamut 35. Accordingly, the brightness of the transmitted light can be improved.

The R color portion in red has a smaller thickness than each of the B color portion in blue and the G color portion in green. With this configuration, the amount of red light in the transmitted light increases compared with the case that the R, G, and B color portions have the same thickness, although the color gamut of red in the transmitted light decreases. As a result, the brightness of the transmitted light can be improved.

The color filters 19 are configured such that a chromaticity of red in the transmitted light is outside the common gamut 35 on both of the CIE 1931 color space chromaticity diagram and the CIE 1976 color space chromaticity diagram. The common gamut 35 is a region shared by NTSC color gamut 33 corresponding to NTSC standard and EBU color gamut 34 corresponding to EBU standard. With this configuration, since the chromaticity of red in the transmitted light is outside the common gamut 35, the color gamut of red in the transmitted light is expanded compared the case where the chromaticity of red in the transmitted light is inside the common gamut 35. As a result, color reproducibility can be improved.

The R color portion in red has a larger thickness than each of the B color portion in blue and the G color portion in green. With this configuration, the color gamut of red in the transmitted light is expanded compared with the case that the color portions have the same thickness, although the amount of red light in the transmitted light decreases. Accordingly, high color reproducibility can be obtained.

The color filters 19 are configured such that a chromaticity of green in the transmitted light is outside the common gamut 35 on both of the CIE 1931 color space chromaticity diagram and the CIE 1976 color space chromaticity diagram. The common gamut 35 is a region shared by NTSC color gamut 33 corresponding to NTSC standard and EBU color gamut 34 corresponding to EBU standard. With this configuration, since the chromaticity of green in the transmitted light is outside the common gamut 35, the color gamut of green in the transmitted light is expanded compared with the case that the chromaticity of green in the transmitted light is inside the common gamut 35. Accordingly, high color reproducibility can be obtained.

The color filters 19 are configured such that a chromaticity of yellow in the transmitted light is outside the common gamut 35 on both of the CIE 1931 color space chromaticity diagram and the CIE 1976 color space chromaticity diagram. The common gamut 35 is a region shared by NTSC color gamut 33 corresponding to NTSC standard and EBU color gamut 34 corresponding to EBU standard. With this configuration, since the chromaticity of yellow in the transmitted light is outside the common gamut 35, the color gamut of yellow in the transmitted light is expanded compared with the case that the chromaticity of yellow in the transmitted light is inside the common gamut. Accordingly, high color reproducibility can be obtained.

The color gamut of the transmitted light covers 70% of the NTSC color gamut 33. With this configuration, sufficient color reproducibility for displaying image can be achieved, and thus high display quality can be achieved.

The cold cathode tubes 25 are arranged so as to be parallel with each other. With this configuration, the uneven brightness of the transmitted light is less likely to occur.

### Second Embodiment

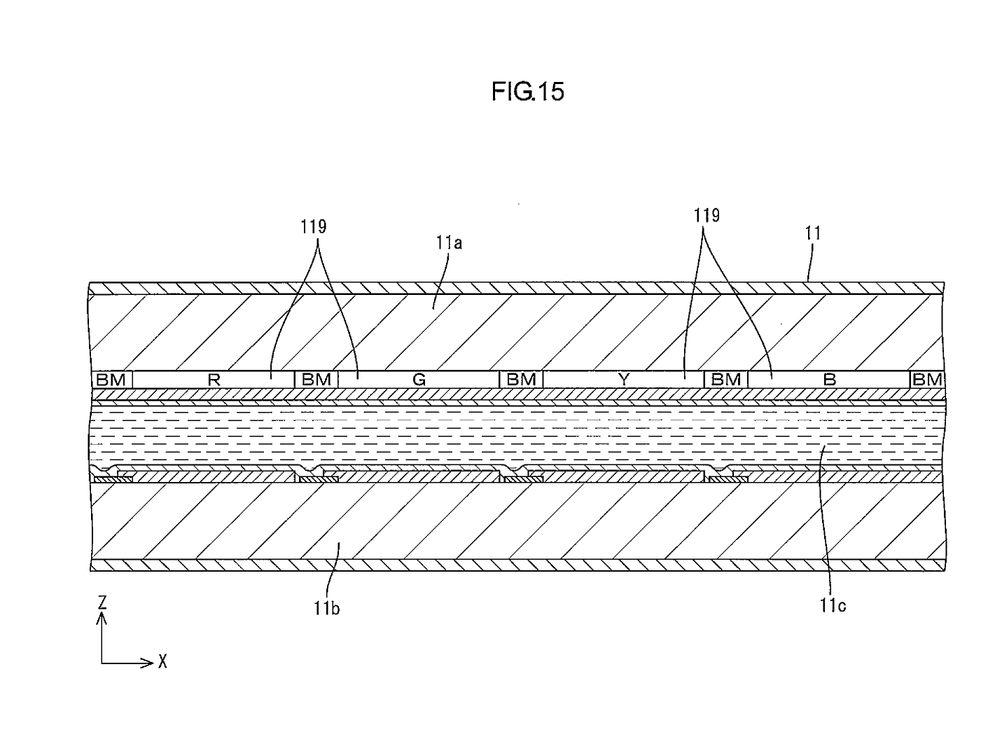

The second embodiment of the present invention will be explained with reference to FIG. 15. In the second embodiment, the B color portion in blue included in the color filter 119 includes pigment in a different concentration (content) than the R, G, and Y color portions. The same configurations, operations, and effects as those in the first embodiment will not be explained.

As illustrated in FIG. 15, the R, G, B, and Y color portions included in the color filter 119 according to the present embodiment has the same thickness, but the B color portion in red includes the pigment in a different concentration than the R, G, and Y color portions. Accordingly, the chromaticity of the R, G, B, and Y color portions vary according to the pigment concentration. Along with the decrease in the pigment concentration in a color portion, the amount of the light transmitted through the color portion increases, but the chromatic purity thereof and the color gamut thereof decreases. Conversely, along with the increase in the pigment concentration in a color portion, the chromaticity purity thereof increases and the color gamut tends to be expanded, but the amount of light transmitted through the color portion decreases. That is, the smaller the pigment concentration of the R, G, B, and Y color portions is, the higher the brightness and the lower the color reproducibility become. Conversely, the larger the pigment concentration is, the higher the color reproducibility and the lower the brightness become. The same result may be obtained by applying the color filter 119 having such a configuration to Examples 2 to 4 described in the second comparative experiment of the above first embodiment.

Similar to the above, the color filter 119 may include the R color portion in red that has a different pigment concentration than the G, B, and Y color portions. The same result may be obtained by applying the color filter 119 having such a configuration to Examples 5 to 9 described in the second comparative experiment of the above first embodiment.

According to the present embodiment, as described above, the pigment is dispersedly contained in the R, G, B, and Y color portions and the B color portion in blue has a lower pigment concentration than the R color portion in red and the G color portion in green. When the B color portion in blue has the pigment concentration lower than that of the color portion in red and the G color portion in green, the amount of blue light passing through the color portions increases compared with the case that the R, G, B, and Y color portions have the same pigment concentration, although the color gamut of blue in the transmitted light decreases. Accordingly, the reduction in brightness of the cold cathode tube 25 that may occur in the chromaticity adjustment of the cold cathode tube 25 is less likely to occur. Further, the brightness of the transmitted light is improved.

The R, G, B, and Y color portions in red, green, blue and yellow have substantially equal thicknesses. With this configuration, capacitance between the substrates 11a, 11b at the R, G, B, and Y color portions included in the color filters 19 can be substantially equal. Thus, optical characteristics of the liquid crystal layer 11c that is the substance provided between the substrates 11a, 11b can be readily controlled by an application of electric field. As a result, light transmissibility with respect to the R, G, B, and Y color portions can be readily controlled, and thus a circuit design relating to the display panel 11 can be simplified.

### Other Embodiments

The present invention is not limited to the embodiments explained in the above description with reference to the drawings. The following embodiments may be included in the technical scope of the present invention, for example.

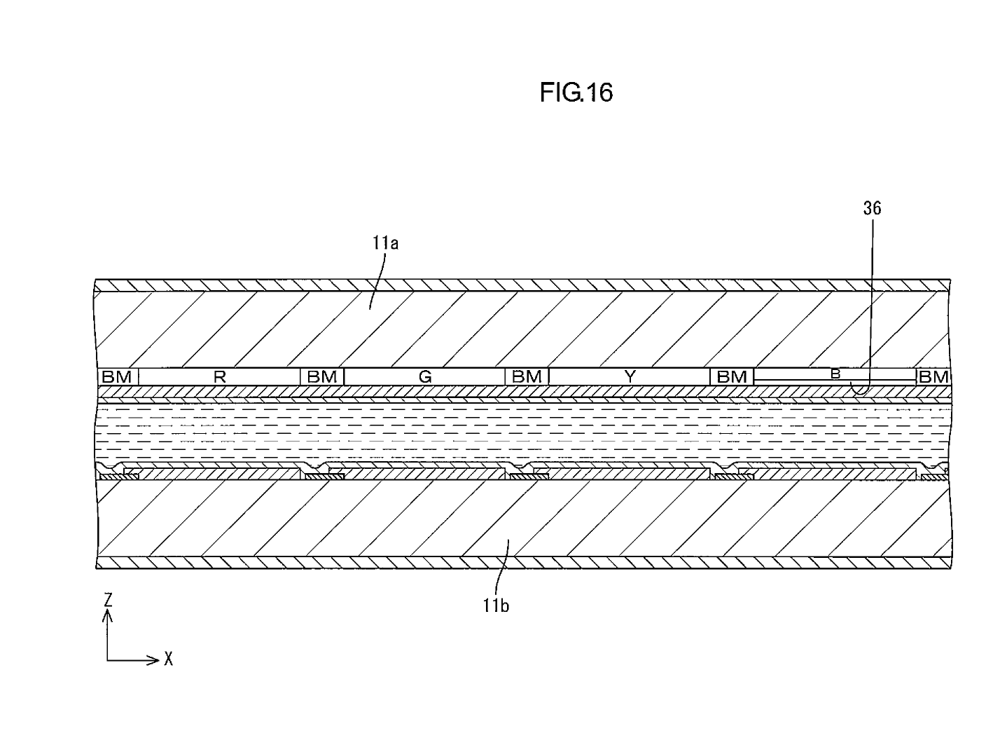

(1) In the above first embodiment, the color portion in blue has a thickness smaller than that of the other color portions (see FIG. 12). However, the following modification may be made. As illustrated in FIG. 16, a transparent spacer 36 may be laminated on the B color portion in blue. The total thickness of the B color portion and the spacer 36 may be equal to the thickness of the R, G, and Y color portions. With this configuration, capacitance between the substrates 11a, 11b at the R, G, B, and Y color portions can be equal. This is advantageous in circuit design. This technology that uses the spacer 36 may be applied to the R color portion in red.

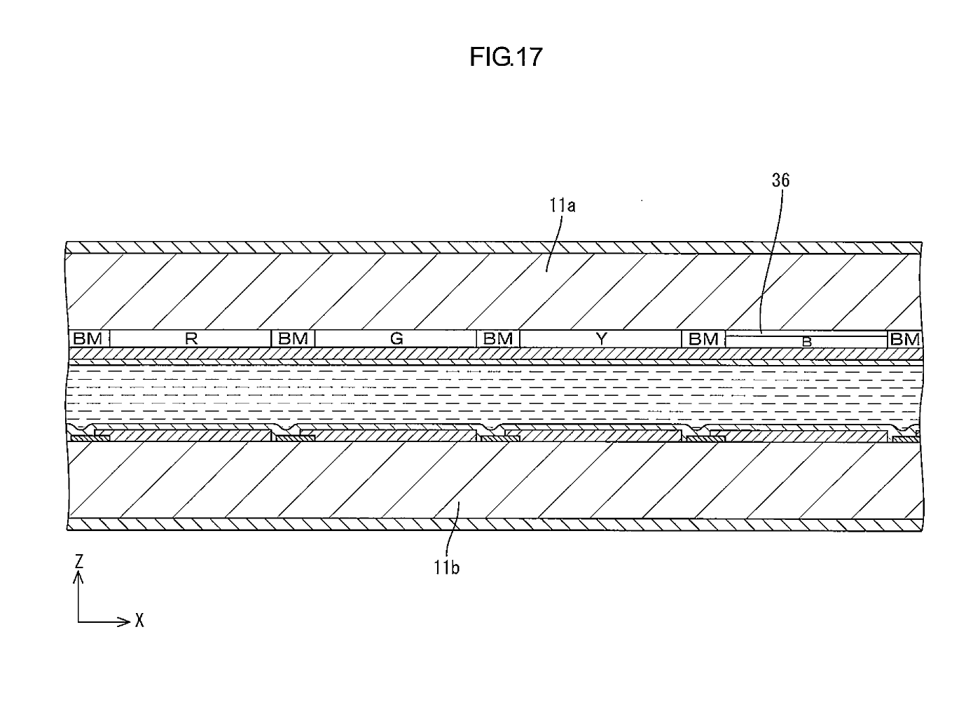

(2) FIG. 17 illustrates a modification of the above (1). The B color portion in blue and the spacer 26 may be arranged in the opposite order from the above (1).

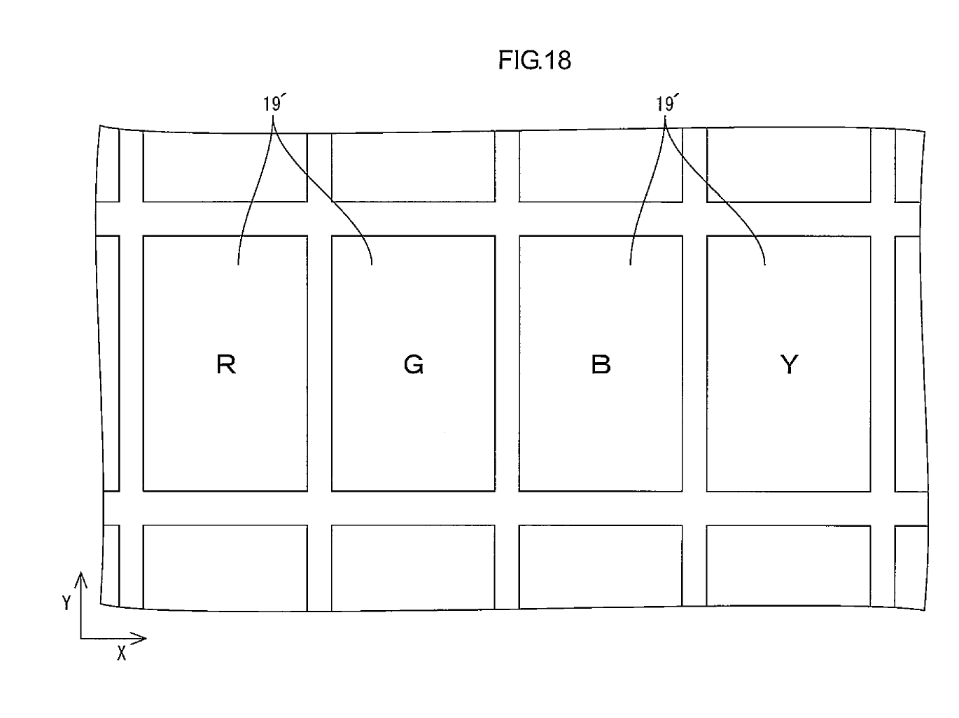

(3) In addition to the above embodiments, the arrangement of the color portions of the color filter included in the liquid crystal panel may be suitably changed. For example, as illustrated in FIG. 18, the R, G, B, and Y color portions included in the color filters 19′ may be arranged along the X-axis direction in an order of: the R color portion in red, the G color portion in green, the B color portion in blue, and the Y color portion in yellow, from the left in FIG. 18.

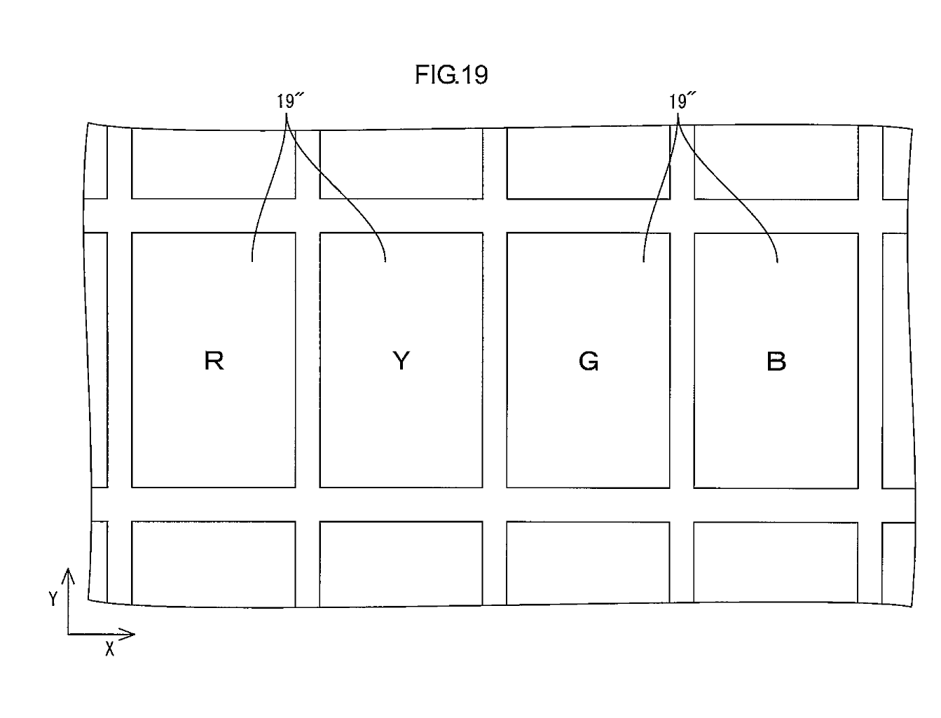

(4) In addition to the above (1), as illustrated in FIG. 19, the R, G, B, and Y color portions included in the color filters 19″ may be arranged along the X-axis direction in an order of: the R color portion in red, the Y color portion in yellow, the G color portion in green, and the B color portion in blue, from the left in FIG. 19.

(5) In the above first embodiment, the chromaticity of blue in the transmitted light has the y value of 0.055 or larger and the V′ value of 0.147 or larger. However, the chromaticity of blue may have the y value of less than 0.055 and the v′ value of less than 0.147.

(6) In the above first embodiment, the color portion in blue of the color filter has a thickness that is 57.1 to 85.8% of the thickness of each of the color portions in red and green. However, the thickness ratio of the color portion in blue may be lower than 57.1% or higher than 85.8%. Even in such a case, the thickness ratio of the color portion in blue is preferably in a range of 50% to 90%. The color portion in blue may have any thickness other than the thickness disclosed in Example 1.

(7) The first embodiment and the second embodiment may be employed in combination such that both of the thickness and the concentration of the color portion in blue differs from the other color portions.

(8) In the above embodiments, the color portions of the color filters contains the pigment. However, the color portions of the color filters may contain dye. In such a case, like the second embodiment, a concentration of the dye contained in the color portion in blue may be different from that in the other color portions and the thickness of all color portions may be the same.

(9) In the above embodiments, the color filters are configured such that the chromaticity of the color portions in blue, red, green, and yellow in the transmitted light is outside the common gamut on both of the CIE 1931 color space chromaticity diagram and the CIE 1976 color space chromaticity diagram. The common gamut is a region shared by the NTSC color gamut corresponding to NTSC standard and the EBU color gamut corresponding to EBU standard. However, the chromaticity of the color portions may be outside the common gamut on at least one of the CIE 1931 color space chromaticity diagram and the CIE 1976 color space chromaticity diagram.

(10) In the above first embodiment, the cold cathode tubes are housed in the chassis at an equal interval. However, the cold cathode tubes may be arranged at an unequal interval. The specific number and the interval of the cold cathode tubes may be suitably changed.

(11) In the above embodiment, the liquid crystal panel and the chassis are set in the vertical position with the short-side directions thereof aligned with the vertical direction. However, the liquid crystal panel and the chassis may be set in the vertical position with a long-side direction thereof aligned with the vertical direction.

(12) In the above embodiments, the TFTs are used as switching components of the liquid crystal display device. However, the technology described herein can be applied to liquid crystal display devices using switching components other than TFTs (e.g., thin film diodes (TFDs)). Furthermore, it can be applied to black-and-white liquid crystal display devices other than the color liquid crystal display device.

(13) In the above embodiments, the liquid crystal display device including the liquid crystal panel as a display panel is used. However, the present invention can be applied to display devices including other types of display panels.

(14) In the above embodiments, the television receiver including the tuner is used. However, the technology can be applied to a display device without the tuner.

### EXPLANATION OF SYMBOLS

10: Liquid crystal display device (Display device), 11: Liquid crystal panel (Display panel), 11a: CF substrate (Substrate), 11b: Array substrate (Substrate), 11c: Liquid crystal layer (Substances, liquid crystals), 12: Backlight unit (Lighting unit), 19: Color filter, 33: NTSC color gamut, 34: 35: EBU color gamut, 35: Common gamut, R: Red color portion, G: Green color portion, B: Blue color portion, Y: Yellow color portion, TV: Television receiver, VC: Image converter circuit.

1. A display device comprising:
a display panel including a pair of substrates, a substance having optical characteristics varying according to an application of electric field and arranged between the substrates, and color filters provided on one of the substrates, the color filters including a plurality of color portions in red, green, blue, and yellow, respectively; and
a lighting unit configured to illuminate the display panel, the lighting unit including cold cathode tubes as light sources,
wherein the color filters are configured such that a chromaticity of blue in transmitted light that is emitted from the cold cathode tubes and passed through the color portions is outside a common gamut on at least one of CIE 1931 color space chromaticity diagram and CIE 1976 color space chromaticity diagram, the common gamut being a region shared by NTSC color gamut corresponding to NTSC standard and EBU color gamut corresponding to EBU standard.

2. The display device according to claim 1, wherein the color filters are configured such that the chromaticity of blue in the transmitted light is inside the EBU color gamut on at least one of the CIE 1931 color space chromaticity diagram and the CIE 1976 color space chromaticity diagram.

3. The display device according to claim 1, wherein the color filters are configured such that the chromaticity of blue in the transmitted light is outside the EBU color gamut on at least one of the CIE 1931 color space chromaticity diagram and the CIE 1976 color space chromaticity diagram.

4. The display device according to claim 1, wherein the color filters are configured such that the chromaticity of blue in the transmitted light has a y value of 0.055 or larger on the CIE 1931 color space chromaticity diagram.

5. The display device according to claim 1, wherein the color filters are configured such that the chromaticity of blue in the transmitted light has a v′ value of 0.147 or larger on the CIE 1976 color space chromaticity diagram.

6. The display device according to claim 3, wherein the color portions in red, green, blue, and yellow have equal areas.

7. The display device according to claim 1, wherein the color portion in blue has a smaller thickness than each of the color portion in red and the color portion in green.

8. The display device according to claim 7, wherein the color portion in red has a thickness substantially equal to that of the color portion in green.

9. The display device according to claim 8, wherein the color portion in yellow has a thickness equal to that of each of the color portion in red and the color portion in green.

10. The display device according to claim 7, wherein the color portion in blue has a thickness that is 50 to 90% of the thickness of each of the color portion in red and the color portion in green.

11. The display device according to claim 10, wherein the color portion in blue has a thickness that is 57.1 to 85.8% of the thickness of each of the color portion in red and the color portion in green.

12. The display device according to claim 11, wherein the color portion in red and the color portion in green each have a thickness of 2.1 μm and the color portion in blue has a thickness of 1.2 to 1.8 μm.

13. The display device according to claim 1, wherein the color portions contain pigments, the color portion in blue has a lower pigment concentration than each of the color portion in red and the color portion in green.

14. The display device according to claim 13, wherein the color portions in red, green, blue, and yellow have substantially equal thicknesses.

15. The display device according to claim 1, wherein the color filters are configured such that a chromaticity of red in the transmitted light is inside the common gamut on at least one of the CIE 1931 color space chromaticity diagram and the CIE 1976 color space chromaticity diagram.

16. The display device according to claim 15, wherein the color portion in red has a smaller thickness than each of the color portion in blue and the color portion in green.

17. The display device according to claim 1, wherein the color filters are configured such that a chromaticity of red in the transmitted light is outside the common gamut on at least one of the CIE 1931 color space chromaticity diagram and the CIE 1976 color space chromaticity diagram.

18. The display device according to claim 17, wherein the color portion in red has a smaller thickness than each of the color portion in blue and the color portion in green.

19. The display device according to claim 1, wherein the color filters are configured such that a chromaticity of green in the transmitted light is outside the common gamut on at least one of the CIE 1931 color space chromaticity diagram and the CIE 1976 color space chromaticity diagram.

20. The display device according to claim 1, wherein the color filters are configured such that a chromaticity of yellow in the transmitted light is outside the common gamut on at least one of the CIE 1931 color space chromaticity diagram and the CIE 1976 color space chromaticity diagram.

21. The display device according to claim 1, wherein the color gamut of the transmitted light covers 70% of the NTSC color gamut.

22. The display device according to claim 1, wherein the cold cathode tubes are arranged so as to be parallel with each other.

23. The display device according to claim 1, wherein the display panel is a liquid crystal panel including liquid crystals as substances that vary optical characteristics according to an application of electric field.

24. A television receiver comprising:
the display device according to claim 1; and
a receiver configured to receive a television signal.

25. The television receiver according to claim 24, further comprising an image converter circuit configured to convert a television signal output from the receiver into red, green, blue and yellow image signals.
